(19) United States
(12) Patent Application Publication
(10) Pub. No.: US 2024/0378492 A1
(43) Pub. Date: Nov. 14, 2024

(54) SYSTEMS AND METHODS FOR TRAINING AND USING A MACHINE-LEARNING MODEL FOR DETERMINING THE SIMILARITY OF ENTITIES

(71) Applicant: SHOPIFY INC., Ottawa (CA)

(72) Inventors: Kshetrajna Raghavan, Fremont, CA (US); Henrique Aveiro, Deerfield Township, OH (US); Farzad Darouian, Seattle, WA (US); Mohammad Hassan Lotfi Froushani, Pittsburgh, PA (US); Miqdad Jaffer, Mississauga (CA)

(21) Appl. No.: 18/315,752

(22) Filed: May 11, 2023

(51) Int. Cl. G06N 20/00

(52) U.S. Cl. CPC G06N 20/00

(57) ABSTRACT

There are many situations in which it is useful to identify similar entities or to quantify how similar one entity is to another. However, similarity is often subjective, making it challenging to determine the similarity of two entities computationally. In order to allow for determining the similarity of entities according to a customizable definition of similarity, a selection of features for determining similarity is received from a user device and a machine-learning model is trained to encode the values of the selected features for a particular entity as a representation. The representations of two different entities may be compared to determine the similarity of the two entities according to the selected features. The trained machine-learning model may, additionally or alternatively, be used for cluster analysis to identify similar groups of entities.

### FIELD

The present application relates to the application of machine-learning for determining the similarity of entities.

### BACKGROUND

There are many situations in which it is useful to identify similar entities or to quantify how similar one entity is to another.

### SUMMARY

Similarity is often subjective, as the similarity between two entities usually depends on how similarity is assessed. For example, image A may be considered similar to image B because both images are of the same object, whereas image A may instead be considered similar to image C because images A and C are on the same webpage. In the context of commerce, store A may be considered similar to store B because stores A and B sell the same category of products, whereas store A may instead be considered similar to store C because stores A and C are both online stores that ship from a same warehouse in New York.

The similarity of two entities depends on the features according to which similarity is determined. There are often a large number of possible features that can be used to determine similarity, and, in practice, similarity may be determined according to more than one feature. This poses a computational challenge for determining the similarity of two entities. It may not be possible to create a single model that is capable of determining similarity across all of the possible features, and combinations of those features, that may be used for determining similarity. Although it may be possible to create individual models for each feature and each combination of features, this can pose other computational challenges. In particular, when the number of features is large, this may result in a large array of models that require significant processing time and memory to develop and store. Moreover, training a model may be a problem because there might not be available previously collected/categorized data providing examples of which entities are similar for a given combination of features.

In some embodiments herein, in order to allow for determining the similarity of entities according to different features, a selection of features for determining similarity is received from a user device and a machine-learning model is trained to encode the values of the selected features for a particular entity as a representation, such as a vector representation. The representations of two different entities may be compared to determine the similarity of the two entities according to the selected features. The trained machine-learning model may also or instead be used for cluster analysis to identify similar groups of entities.

The machine-learning model may be trained based on values of the selected features for a set of entities. In particular, one or more values of the selected features for an entity may be distorted to produce a training pair that includes the (undistorted) values of the selected features and a distorted value of at least one of the selected features. A respective noise model that is specific to each feature may be used to determine the distorted values, e.g. to produce distorted values that make sense in the context of each feature. As a result, the set of training pairs may effectively indicate the extent to which feature values of two entities may vary whilst the entities are still considered to be similar. In addition, since the distorted values are determined based on the noise models, the training pairs may be created automatically, enabling the machine-learning model to be trained without supervision by a user. As a result, the machine-learning model may be trained using self-supervised learning.

The noise model for a feature may be developed based on values of that feature for a set of entities. For example, the noise models for features that take numeric values may be based on a distribution of the values of the feature. For other features (e.g. categorical features), the values of the features may be encoded to obtain numeric representations of the feature values. The noise model for a particular feature may then be based on the distribution of the numeric representations of the feature values. Since the numeric representations of two different feature values may indicate a similarity of the two different feature values, the noise model may indicate how likely one feature value is to be substituted by another.

Thus, a machine-learning model may be trained to provide representations that may be used to determine the similarity of two entities or to identify groups of similar entities. The trained machine-learning model may be specific to the selected features such that the representations provided by the trained machine-learning model may be used to determine the similarity of entities according to those selected features. This may be used, for example, as part of a dynamic benchmarking service e.g. for providing, for an entity, the performance metrics of a cohort of other, similar entities.

Technical benefits of some embodiments may include the automatic training of machine-learning models for generating representations of values of features for entities that are specific to a selection of features received from a user device. The representations provided by the trained machine-learning models may be used to assess the similarity of entities, for cluster analysis etc. The machine-learning models may be trained on demand, possibly in real-time or near real-time, enabling the provision of a service that determines the similarity of entities and/or groups similar entities together on demand for a customizable definition of what makes two entities similar. That is, the service may dynamically configure the way similarity is assessed on demand according to (e.g. responsive to) features selected by a user. This allows for the provision of dynamic services, such as a dynamic benchmarking service, whilst avoiding the need to pre-train and store a large array of machine-learning models. In turn, this may reduce the processing resources and memory involved in providing these dynamic services. Moreover, these advantages may be achieved even in the absence of previously collected/categorized data that provides examples of which entities are similar for a given combination of features. More specifically, the training pairs for training a machine-learning model may be created automatically, which enables machine-learning models to be trained in the absence of labelled datasets or supervision from a user.

In some embodiments, a computer-implemented method is provided. The computer-implemented method may comprise obtaining, for each feature in a set of features, a respective noise model. The computer-implemented method may comprise receiving, from a user device, a selection of features from the set of features, e.g. where the selection of features is a selected subset of features in the set of features. In some embodiments, the computer-implemented method might not involve obtaining noise models for all of the features in the set of features. For example, the computer-implemented method may involve obtaining noise models for only the selected features. The computer-implemented method may comprise for each entity of a first plurality of entities used for training, obtaining a value for each of the selected features. The computer-implemented method may comprise training a machine-learning model using a first set of training pairs, each training pair in the first set of training pairs comprising respective entity data paired with corresponding distorted entity data. The respective entity data may comprise values of the selected features for a respective entity in the first plurality of entities. The corresponding distorted entity data may be obtained by distorting a value of at least one of the selected features for the respective entity based on the respective noise model for the at least one of the selected features. The computer-implemented method may comprise inputting, to the trained machine-learning model, values of the selected features for a particular entity to obtain a representation of the values of the selected features for that entity. In some embodiments, a representation may be a vector representation, e.g. a vector having a respective numeric representation for each selected feature. In some embodiments, the trained machine-learning model may obtain the representation by encoding the values of the selected features for the particular entity. The computer-implemented method may comprise determining a similarity between the particular entity and another entity based on the representation for the particular entity.

The first plurality of entities may include at least one of the particular entity or the other entity. Alternatively, the training set might not include the entities whose selected feature values are input into the trained machine-learning model.

The computer-implemented method may comprise inputting, to the trained machine-learning model, values of the selected features for the other entity to obtain a representation of the values of the selected features for the other entity. The similarity between the particular entity and the other entity may be determined based on the representation for the particular entity and the representation for the other entity, e.g. by comparing the representation for the particular entity to the representation for the other entity such as by determining a similarity score, which may comprise evaluating a difference (e.g. distance) between the two representations.

The other entity may comprise two or more other entities. That is, for multiple entities, including the other entity, the values of the selected features for each of those entities may be input to the trained machine learning model to obtain a respective representation. Determining the similarity between the two or more other entities and the particular entity may comprise inputting, to the trained machine-learning model, values of the selected features for the two or more other entities to obtain representations of the values of the selected features for the two or more other entities, and determining similarity scores for the two or more other entities compared to the particular entity based on the representations for the particular entity and the two or more other entities. A similarity score for two entities might represent, for example, the difference (e.g. distance) between the representation of those two entities. The computer-implemented method may comprise identifying a subset of the two or more other entities as similar to the particular entity based on their respective similarity scores. The computer-implemented method may further comprise providing information relating to the subset of the two or more other entities for output at a user interface of the user device. The computer-implemented method may further comprise receiving, from the user device, an indication of one or more filters to be applied. The computer-implemented method may further comprise filtering the subset of the two or more other entities to obtain a filtered set of entities. The computer-implemented method may further comprise providing information relating to the filtered set of entities for output at a user interface of the user device.

The particular entity and the other entity may be included in a second plurality of entities. Determining the similarity between the particular entity and the other entity may comprise determining the similarity between the particular entity and the other entity to cluster the second plurality of entities into one or more groups based on the representations for the second plurality of entities.

The computer-implemented method may comprise receiving, from the user device, an indication of one or more filters to be applied. The computer-implemented method may comprise selecting the particular entity from a larger group of entities based on the one or more filters.

Training the machine-learning model using the first set of training pairs may comprise training the machine-learning model using the first set of training pairs and a first label. The first label may indicate that, for each training pair in the first set of training pairs, the entity data and the distorted entity data in that training pair are similar to one another. A second set of training pairs and a second label may also be used to train the machine-learning model. Each training pair in the second set of training pairs may comprise entity data including values of the selected features for each of two different entities in the first plurality of entities. The second label may indicate that, for each training pair in the second set of training pairs, the entity data for the different entities are dissimilar to one another.

Obtaining, for each feature in a set of features, the respective noise model may comprise obtaining the noise model for a particular feature by performing operations including obtaining values of the particular feature for a second plurality of entities, e.g. the values including a respective value of the particular feature for each entity in the second plurality of entities. The operations may include determining the noise model for the particular feature based on the values of the particular feature for the second plurality of entities. The noise model for the particular feature in the set of features may be based on a distribution of the values of the particular feature for the second plurality of entities.

Determining the noise model for the particular feature may comprise encoding, for each entity in the second plurality of entities, the value of the particular feature to obtain respective numeric data for that entity. Determining the noise model for the particular feature may comprise determining the noise model for the particular feature based on a distribution of the numeric data for the second plurality of entities. The noise model for the particular feature may be based on a Gaussian distribution of the numeric data for the second plurality of entities. The particular feature may comprise a category.

The set of features may comprise the selected features and one or more other features. The values of the one or more features for the first plurality of entities may be excluded from the first set of training pairs (e.g. values of the one or more other features are not used to train the machine-learning model). Inputting, to the trained machine-learning model, values of the selected features for a particular entity may comprise inputting values of only the selected features to the trained machine-learning model (e.g. such that values of the one or more other features are not input to the trained machine-learning model).

A system is also disclosed that is configured to perform the methods disclosed herein, such as any of the methods described above. For example, the system may include at least one processor to directly perform (or cause the system to perform) the method steps. The system may also comprise a network interface (e.g. to receive, from a user device, a selection of features from a set of features). In some embodiments, the system may include a memory storing processor-executable instructions that are executed by the processor to cause the system to perform the methods disclosed herein.

In another embodiment, there is provided a computer readable medium having stored thereon computer-executable instructions that, when executed by a computer, cause the computer to perform operations of the methods disclosed herein, such as operations of the methods described above. The computer readable medium may be non-transitory.

### BRIEF DESCRIPTION OF THE DRAWINGS

Embodiments will be described, by way of example only, with reference to the accompanying figures wherein:

FIG. 1 illustrates a system according to one embodiment.

FIG. 2 illustrates a computer-implemented method according to one embodiment.

FIG. 3 illustrates a model trainer according to one embodiment.

FIG. 4 illustrates an example of a training pair according to one embodiment.

FIGS. 5-9 are examples of an interface for a benchmarking service according to one embodiment.

FIG. 10 is a block diagram of an e-commerce platform, according to one embodiment.

FIG. 11 illustrates a home page of an administrator, according to one embodiment.

FIG. 12 is a block diagram illustrating an e-commerce platform including a similarity engine, according to one embodiment.

### DETAILED DESCRIPTION

For illustrative purposes, specific example embodiments will now be explained in greater detail below in conjunction with the figures.

### Example System for Determining the Similarity of Entities

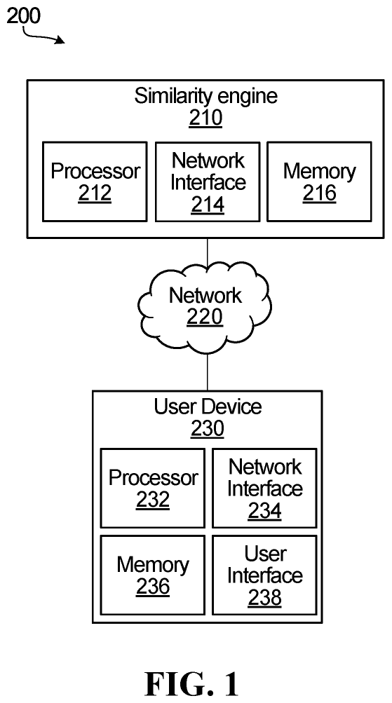

FIG. 1 illustrates a system 200 according to one embodiment. The system includes a similarity engine 210 connected to a user device 230 via a network 220. Only a single user device 230 is illustrated, but it will be appreciated that the similarity engine 210 may, in general, be connected to one or more user devices 230.

The similarity engine 210 includes a processor 212, network interface 214 and a memory 216. The processor 212 directly performs, or instructs the similarity engine 210 to perform, the operations described herein of the similarity engine 210, e.g. operations such as obtaining noise models, receiving a selection of features, training a machine-learning model, determining a similarity etc. The processor 212 may be implemented by one or more general purpose processors that execute instructions stored in a memory (e.g. in memory 216) or stored in another computer-readable medium. The instructions, when executed, cause the processor 212 to directly perform, or cause the similarity engine 210 to perform the operations described herein. In other embodiments, the processor 212 may be implemented using dedicated circuitry, such as a programmed FPGA, a GPU, or an ASIC. In some embodiments, a computer-readable medium may be provided (e.g. separately to the similarity engine 210). The computer-readable medium may be non-transitory. The computer-readable medium may store instructions that, when executed by a computer, cause the computer to perform any of the operations of the similarity engine 210 described below. Also, in some embodiments one or more of the operations described herein as being performed by the similarity engine 210 may alternatively be performed locally on the user device 230, e.g. the user device 230 might determine similarity based on outputs from a trained machine-learning model implemented by the similarity engine 210.

The network interface 214 is for communicating with the user device 230 over the network 220. The network interface 214 may be implemented as a network interface card (NIC), and/or a computer port (e.g. a physical outlet to which a plug or cable connects), and/or a network socket, etc., depending upon the implementation.

The similarity engine 210 further includes the memory 216. A single memory 216 is illustrated in FIG. 1, but in implementation the memory 216 may be distributed.

In some embodiments, the processor 212, memory 216, and/or network interface 214 may be located outside of the similarity engine 210.

The user device 230 includes a processor 232, a network interface 234, a memory 236 and a user interface 238. The processor 232 directly performs, or instructs the user device 220 to perform, the operations of the user device 230 described herein e.g. sending a selection of features, outputting information at the user interface 238 etc. The processor 232 may be implemented by one or more general purpose processors that execute instructions stored in a memory (e.g. the memory 236) or stored in another computer-readable medium. The instructions, when executed, cause the processor 232 to directly perform, or instruct the user device 230 to perform, the operations described herein. In other embodiments, the processor 232 may be implemented using dedicated circuitry, such as a programmed FPGA, a GPU or an ASIC. In some embodiments, a computer-readable medium may be provided (e.g. separately to the user device 230). The computer-readable medium may be non-transitory. The computer-readable medium may store instructions that, when executed by a computer, cause the computer to perform any of the operations of the user device 230 described below.

The network interface 234 is for communicating with the similarity engine 210 over the network 220. The structure of the network interface 234 will depend on how the user device 230 interfaces with the network 220. For example, the network interface 234 may comprise a transmitter/receiver with an antenna to send and receive wireless transmissions to/from the network 220. This may be particularly appropriate in examples in which the user device 230 is a mobile phone, laptop, or tablet. If the user device 230 is connected to the network 220 with a network cable, the network interface 234 may comprise a NIC, and/or a computer port (e.g. a physical outlet to which a plug or cable connects), and/or a network socket, etc. This may be particularly appropriate in examples in which the user device 230 is a personal computer or a cash register (e.g. a till).

The user device 230 also includes the memory 236. A single memory 236 is illustrated in FIG. 1, but in implementation the memory 236 may be distributed. The memory 236 may be for storing information received from the similarity engine 210.

The user interface 238 is for allowing the user to input information to the user device 230. The user interface 238 may additionally be for outputting information to a user. The user interface 238 may be implemented as touchscreen, and/or a keyboard, and/or a mouse, etc. The user interface 238 may include a display e.g. in addition to a keyboard and/or a mouse. Although the user interface 238 is illustrated as being part of the user device 230, in some embodiments the user interface 238 may be associated with (e.g. connected to) the user device 230.

### Example Method for Providing Information Relating to a Similar Entity

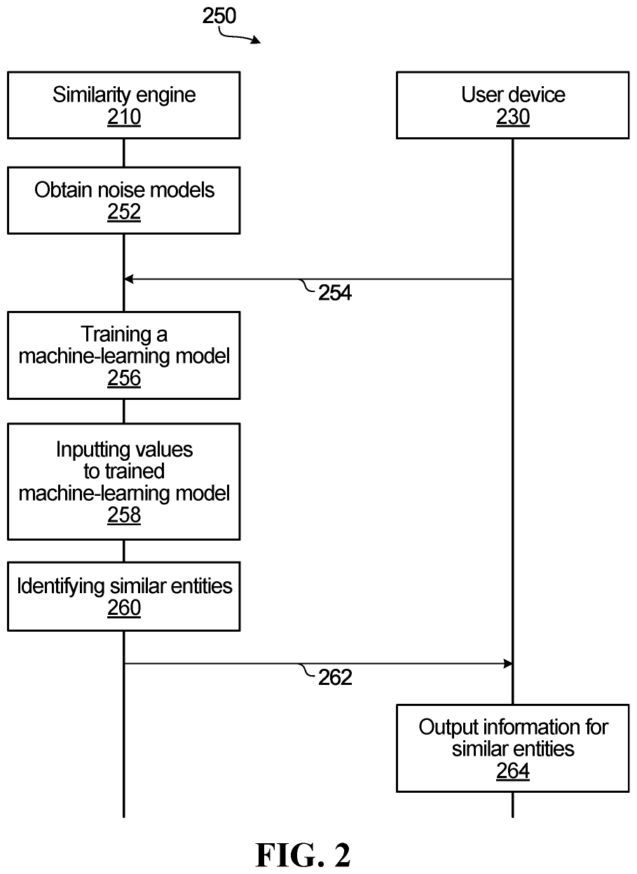

FIG. 2 illustrates a computer-implemented method 250 according to one embodiment.

The method 250 may be for providing information relating to at least one entity that is similar to a particular entity. As described in more detail below, the method 250 may involve identifying a subset of two or more other entities that are similar to the particular entity based on features selected from a set of features. As such, the method 250 may enable a user to select one or more features for determining whether an entity is similar to a particular entity and, based on the selected features, another entity may be identified as being similar to the particular entity. Not all of the steps in the method 250 are necessary in all embodiments. In the foregoing description, steps of the method 250 are described as being performed by either the similarity engine 210 or the user device 230. In some embodiments, some or all of the steps of the method 250 may be performed by one or more other devices.

The method 250 may begin, in step 252, with the similarity engine 210 obtaining noise models. The noise models includes a respective noise model for each feature in the set of features. The set of features may include two or more features. It will be appreciated that the particular features included in the set of features may depend on the context in which the method 250 is applied. For example, in the context of determining a similarity of houses, the features may include various characteristics of the house such as the age, sale price, construction material, number of bedrooms, number of bathrooms etc. The set of features may include one or more different types of features such as categorical features (e.g. features for which the values may be selected from a finite set of values), numeric features, binary features (e.g. features that may taken one of two values), textual features etc.

The noise model for a particular feature may be based on (e.g. developed based on) values of that feature. The values of that feature may be for a plurality of entities. For example, the noise model for house prices may be developed based on the sale prices of a set of houses. The values of that feature may also include values of that feature for a particular entity at different points in time (e.g. over a time interval). For example, the noise model for the number of wireless devices connected to a cell may be developed based on a time series of the number of wireless devices connected to the cell over a period of time.

The form and/or development of a noise model for a particular feature may depend on the feature. The noise models for features that take numeric values may be based on a distribution (e.g. a probability distribution) of the values of the feature. For example, the noise model for a height of a person may be based on a distribution of people in a sample (e.g. group) of people. Since height usually follows a Gaussian (normal) distribution, the noise model for a person's height may be based on a Gaussian distribution of people in the sample.

For a feature that does not take numeric values (e.g. a non-numeric feature), the noise model for that feature may be based on a distribution of numeric representations of the values of that feature. The numeric representations may be obtained by encoding the values of the feature. This may be particularly appropriate for categorical features (e.g. features that comprise a category), features that include textual information and/or features that include image data etc. The numeric representations of the feature values may be numbers representing the feature values and the noise model may be a distribution of those numbers. For example, for a feature “Country”, the number “2” may represent the value “Canada” and the number “1” may represent the value “India”.

For a binary feature (e.g. a feature that may take one of two values), the values of the feature may be encoded as one of two numeric values (e.g. a 0 or 1). That is, the numeric representation of the values of the binary feature may take one of two numeric values. For example, for a feature that may take a value of True or False, each value equal to True may be encoded as 1, and each value equal to False may be encoded as 0. The noise model for a binary feature may be based on a binomial distribution (e.g. a Bernoulli distribution) of the numeric representations of the values of the binary feature.

In some embodiments, the numeric representation of a value of a feature may comprise a numeric vector, which may alternatively be referred to as an embedding. The noise model for that feature may comprise a distribution of the numeric vectors representing the values of that feature. This may be particularly appropriate for categorical features, textual features and/or features including image data etc. A numeric vector may be, for example, a sequence, set, or tuple of numbers. The numeric vectors corresponding to two particular feature values may represent those feature values in a vector space such that the distance between the two numeric vectors indicates a similarity of the two feature values. That is, the more similar the feature values, the smaller the distance between their corresponding numeric vectors. Thus, the numeric vectors of two different feature values may indicate a similarity of the two different feature values.

In some embodiments, the noise model for a particular feature may be determined by training a machine-learning model, referred to as an embedding model, for determining embeddings of values for that feature, inputting the values for that feature into the embedding model to obtain embeddings, and determining a distribution of the embeddings. The embedding model may be trained based on values of a set of features for a plurality of entities, in which the set of features includes the particular feature (e.g. the feature the noise model is for) and one or more other features. The set of features may be the same set of features for which the noise models are obtained in step 252 or a different set of features. Training the embedding model may involve normalizing the values of the one or more other features for the plurality of entities and, for each entity in the plurality of entities, labelling the normalized values of the one or more other features for that entity with the value of the particular feature for that entity. In this context, normalization of the values of a feature may refer to multiplying the values of that feature by a factor to constrain the values of that feature to a particular range of values (e.g. between 0 and 1). The embedding model may be trained using the labelled normalized values e.g. using supervised learning or semi-supervised learning. For example, in the context of commerce in which stores having certain features will be compared, an embedding model for the feature “Country” may be trained using feature values for a set of online stores, in which each online store has the following features: gross merchandise value (GMV), average order value (AOV), number of daily sessions (e.g. number of sessions per day) and country (e.g. indicating a primary market). The GMV, AOV and number of daily sessions may be normalized, and the normalized feature values for each online store may be labelled with its country. The labelled normalized feature values may be used to train an embedding model (e.g. using supervised learning or semi-supervised learning).

In some embodiments, the similarity engine 210 may train the embedding model. In other embodiments, the similarity engine 210 may receive the (trained) embedding model.

Thus, in some embodiments the noise model for a feature may be developed by encoding values of that feature to obtain numeric vectors representing the values of that feature and basing the noise model on a distribution of the numeric vectors. The distribution may be a multivariate distribution, such as a multivariate normal (Gaussian) distribution. For example, the noise model for a categorical feature (e.g. a feature comprising a category) may be based on a multivariate Gaussian distribution of numeric vector representing that categorical feature. A noise model for a feature determined based on the distribution of numeric vectors representing values of that feature may indicate how likely one feature value is to be substituted by another. Therefore, the noise model for a feature may be developed by encoding the values of the feature to obtain numeric vectors (e.g. embeddings) that represent the feature values and determining a distribution of the numeric vectors.

In general, the noise model for a feature may be developed based on a distribution of the values of that feature or a distribution of a numeric representation (e.g. a numeric vector) of the values of that feature. In some embodiments, the probability distribution for a noise model may be determined based at least in part on the feature values used for training the machine-learning model. The probability distribution for the noise model may, additionally or alternatively, be determined based on other data (e.g. data external to the training set).

In some embodiments, the similarity engine 210 may develop one or more (e.g. all) of the noise models itself. For example, the similarity engine 210 may receive values of a particular feature from another device (e.g. over the network interface 214) and develop a noise model for that feature based on the received values. In another example, the similarity engine 210 may retrieve values of a particular feature from memory (e.g. the memory 216) and develop a noise model for that feature based on the retrieved values.

In some embodiments, the similarity engine 210 may obtain the noise models by retrieving one or more (e.g. all) of the noise models from a memory (e.g. the memory 216 of the similarity engine 210). The similarity engine 210 may obtain the noise models by receiving one or more (e.g. all) of the noise models from another device (e.g. via the network interface 214 of the similarity engine 210), such as a server or a database. In some embodiments, the similarity engine 210 may receive two or more (e.g. all) of the noise models from more than one device. For example, noise models for different features may be distributed across multiple devices. The similarity engine 210 may thus collate noise models received from multiple devices. In some embodiments, the similarity engine 210 may receive one or more of the noise models on request. For example, the similarity engine 210 may send, to one or more other devices, a request for one or more of the noise models for the set of features. The similarity engine 210 may receive, in response, the requested noise models.

In some embodiments, the similarity engine 210 may use a combination of the approaches described above to obtain the noise models in step 252. For example, the similarity engine 210 may receive at least one of the noise models from another device, retrieve at least one of the noise models from memory and/or develop at least one of the noise models.

In step 254, the similarity engine 210 may receive, from the user device 230, a selection of features from the set of features. The selected features may be the features that are to be used for identifying similar entities. That is, the selection of features may indicate which features that are to be considered (e.g. which features are important) when assessing whether entities are similar to one another.

The similarity engine 210 may receive the selection of features via the network interface 214, for example. The user device 230 may transmit the selection of features to the similarity engine 210 via the network interface 234. The selection of features may include some, but not all of the features in the set of features. That is, the selection of features may be a subset of the set of features.

In some embodiments, the user device 230 may output the set of features on the user interface 238 and the user may select a subset of the outputted features. The similarity engine 210 may receive the selection of features from the user device 230 in any suitable way. For example, the user device 230 may send the names of the selected features to the similarity engine 210. In another example, each feature in the set of features may be uniquely associated with a respective identifier and the user device 230 may send the identifiers for the selected features to the similarity engine 210. In general, the similarity engine 410 may receive, in step 254, an indication of the subset of features that are selected by the user.

In some embodiments, the selection of features may be received from the user device 230 as part of a request for information relating to entities that are similar to the particular entity. Alternatively, the similarity engine 210 may receive the request for information separately to the selection of features. As a further alternative, the request for information may be omitted. Thus, for example, the receipt of the selection of the features in step 254 may indicate, without an explicit request, that information relating to entities that are similar to the particular entity is to be sent to the user device 230.

In some embodiments, the request for information may include an indication of the particular entity for which similar entities are to be identified. Returning to the example of houses mentioned above, a user may have found a particular house that they like but is no longer available. The user may indicate that they wish to find houses that are similar according to a number of features e.g. age, sale price, location etc. The user device 430 may thus, in step 254 send an indication of those particular features to the similarity engine 210. The user device 430 may also send an indication of (e.g. an identifier of) that particular house.

In some embodiments, the similarity engine 210 might not receive (e.g. from the user device 230) an explicit indication of the particular entity for which similar entities are to be identified. The particular entity may be related to the user device 230 and the similarity engine 210 may identify the particular entity based on the user device 230 (e.g. based on an identity of the user device 230 or an account associated with, e.g. logged in at, the user device 230). For example, the particular entity may be an online store operated by a merchant and the merchant may be logged into an account for the online store at the user device 230. The similarity engine 210 may determine (e.g. when the selection of features is received in step 254), that the account relates to the online store, and thus that the selection of features is for identifying stores that are similar to the merchant's online store.

In some embodiments, step 254 may be performed prior to step 252. In some such embodiments, the noise models obtained in step 252 might only relate to the features selected in step 254.

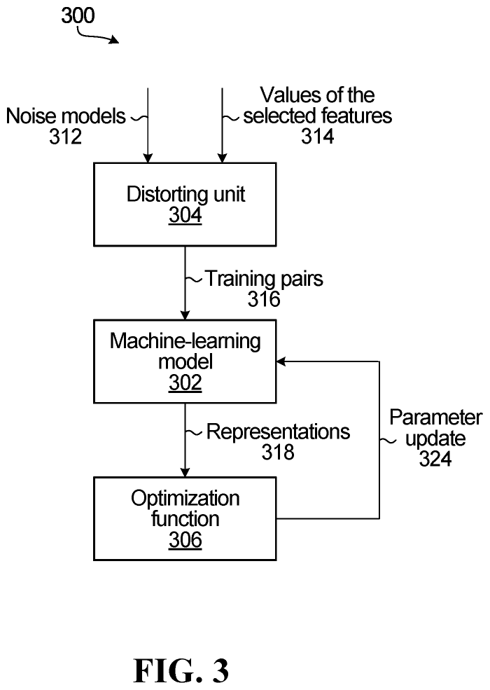

In step 256, the similarity engine 210 may train a machine-learning model based on the selection of features received in step 254. The trained machine-learning model may be specific to the selection of features. The machine-learning model may be trained to generate, based on values of features (e.g. of the selected features) for an entity, a representation of the values of those feature for that entity. The representation may comprise a numeric representation, such as a numeric vector (e.g. an embedding). The trained machine-learning model may generate representations such that representations for similar entities (as defined by the selected features) will have representations that are close to one another. The training of the machine-learning model is described in more detail below in respect of FIG. 3.

In some embodiments, values of the features that were not selected might not be used for training the machine-learning model. For example, the set of features may comprise the selected features and one or more other features. The values of the one or more other features may be excluded from the values used to train the machine learning model (e.g. may be excluded from the first set of training pairs discussed below in respect of FIG. 3).

In an alternative embodiment, the training in step 256 occurs without specific selection of features in step 254. For example, before selection in step 254, different models are trained on different sets of features, and when selection occurs in step 254, the trained model corresponding to the selected set of features is obtained.

In step 258, the similarity engine 210 may input, to the trained machine-learning model, values of the selected features for a particular entity and two or more other entities, to obtain representations of the values of the selected features for those entities.

The representations may comprise numeric representations of the values of the selected features. In this context, a numeric representation may comprise, for example, a numeric vector (e.g. an embedding). The numeric vector for a particular entity may thus represent the values of the selected features for that entity in a vector space. A numeric vector may be, for example, a sequence, set, or tuple of numbers. In one example, if there are K selected features, the input to the trained machine-learning model includes the value of each of the K selected features for (e.g. associated with) the particular entity. That is, there are K values for the particular entity input to the trained machine-learning model, and each one of the K values is the respective feature value associated with a respective different one of the K selected features for the particular entity. The output to the trained machine-learning model includes a multi-dimensional numeric vector (e.g. where the number of dimensions might equal K), which is the representation of the K values of the selected features for the particular entity.

In some embodiments, values of the features that were not selected might not be input to the trained-machine learning model. For example, the set of features may comprise the selected features and one or more other features. Inputting, to the trained machine-learning model, values of the selected features for a particular entity may comprise inputting values of only the selected features to the trained machine-learning model (e.g. such that values of the one or more other features are not input to the trained machine-learning model). For example, the particular entity (and possibly all of the entities, including the entities used for training) may have associated with it M>K features, but only the selected K features may have their values input to the trained machine-learning model (and possibly only the selected K features are used for training the machine-learning model).

In step 260, the similarity engine 210 may identify a subset of the two or more other entities as similar to the particular entity based on the representation of the values of the selected features for the particular entity and the representations of the values of the selected features for the two or more other entities. The subset of the two or more other entities (e.g. the entities identified as being similar to the particular entity) may be referred to as a cohort.

It will be appreciated that there are many different ways in which the similarity engine 210 may identify which of the two or more entities are similar to the particular entity. In some embodiments, the similarity engine 210 may determine, for each of the two or more other entities, a similarity score indicating a similarity of the respective other entity compared to the particular entity. The similarity score may be based on the representation for that other entity and the representation for the particular entity. For example, the similarity score may be based on a difference (e.g. distance) between the representation for that other entity and the representation for the particular entity. A large difference (e.g. a larger distance) may indicate that the other entity and the particular entity are dissimilar, whilst a smaller difference (e.g. a smaller distance) may indicate that the other entity and the particular entity are similar. In one example, there are K selected features. The value of each of the K selected features associated with the particular entity are input to the trained machine-learning model to obtain a first vector. The value of each of the K selected features associated with the other entity are also input to the trained machine-learning model to obtain a second vector. The selected feature values of the particular entity and the other entity may possibly be input to the trained machine-learning model at the same time (i.e. as part of the same input) to obtain the first vector and the second vector at that same time (i.e. as part of the same output). The distance (e.g. Euclidean distance) between the first vector and the second vector is then computed, and this is the similarity score. A small distance represents a high similarity score (i.e. the two entities are similar), and a large distance represents a low similarity score (i.e. the two entities are dissimilar). There may be a distance threshold that delineates between similar and non-similar, e.g. if the distance is smaller than a particular threshold value than the similarity score may indicate that the two entities are similar.

The similarity engine 210 may identify a subset of two or more entities as similar to the particular entity based on their similarity scores. For example, the similarity engine 210 may select the N entities in the two or more other entities with the highest (or lowest, depending on how it is defined) similarity score for inclusion in the subset, in which Nis an integer (e.g. N=1, 5, 10, 20, 50 etc.). In another example, the similarity engine 210 may select each entity in the two or more other entities with a similarity score that satisfies (e.g. meets, exceeds, or is below, depending on the definition of the similarity score) a threshold value for inclusion in the subset.

In step 262, the similarity engine 210 may send information relating to the subset of the two or more other entities (e.g. information relating to the similar entities) to the user device 230 for output at the user interface 238 of the user device 230.

In some embodiments, the similarity engine 210 may, in step 262, identify the subset of the two or more other entities to the user device 230. For example, the information sent in step 262 may include identifiers for the entities in the subset. Alternatively, the similarity engine 210 might not identify the subset of the two or more other entities to the user device 230.

In some embodiments, the similarity engine 210 may, in step 262, send values of one or more metrics for the entities in the subset to the user device 230. That is, the information sent in step 262 may include values of one or more metrics for the entities in the subset. The metric values may be sent instead or, in addition to, the identifiers. The value of a metric for an entity may be indicative of the performance of the entity. For example, a metric may comprise a performance metric, a benchmark value etc. Alternatively, the value of a metric for an entity may be a quantity that is characteristic of (e.g. descriptive of) an entity without necessarily being linked to performance.

The one or more metrics may be configurable by the user device 230 (e.g. by a user operating the user device 230). For example, a user may select, from a plurality of possible metrics output at the user interface 238 of the user device, the one or more metrics. The similarity engine 210 may receive, from the user device 230, an indication of the selected one or more metrics. The similarity engine 210 may send, in step 262, values of the one or more metrics for the subset of the two or more other entities to the user device 230. That is, the similarity engine 210 may send values of the one or more metrics selected by the user for the entities identified as being similar to the particular entity. In some embodiments, the similarity engine 210 may aggregate the values of the one or more metrics and send the aggregated values to the user device 230 such that the identities of the similar entities might not be identifiable at the user device 230. For example, the average or percentile (e.g. 25^{th}, 50^{th}, and/or 75^{th} percentiles) values of the one or more metrics for the entities identified in step 260 may be determined and sent to the user device 230 in step 262. Sending aggregate values of the metrics may allow the user to benchmark their particular entity against other, similar entities, whilst maintaining the privacy of the other entities. In some embodiments, the number of entities identified in step 260 as being similar may be chosen to prevent individual entities from being identifiable from the information provided in step 262. For example, 20 or more entities may be identified as being similar to the particular entity in step 260 in order to reduce the risk of any of the entities being identifiable from the information provided in step 262.

It will be appreciated that identifiers and/or metric values are merely two examples of the information relating to the entities in the subset that may be sent in step 262. In some embodiments, the similarity engine 210 may send, in step 262, values of at least some of the other features in the set of features for the entities in the subset to the user device 210 in step 262. For example, returning to the example of identifying similar houses mentioned above, the similarity engine 210 may identify a first house as being similar to the particular house based on the features of age, sale price and location selected by the user. The similarity engine 210 may send values of one or more other features of the first house (e.g. an image of the house, a construction material etc.) to the user device in step 230.

In FIG. 2, the similarity engine 210 sends the information to the user device 230 (e.g. over the network 220). In some embodiments, the similarity engine 210 may send the information to another device for output at the user interface 238 of the user device 230. The other device may send the information to the user device 230. In some embodiments, the other device may, based on the information, generate content corresponding to a web page for display on the user interface 238 of the user device 230, in which the web page includes the information. The content may include instructions for providing the web page such as HTML defining the web page, Cascading Style Sheets (CSS), template language, JavaScript, and the like, and/or any combination thereof. The device may send the content to the user device 230 for display on the user interface 238. The device generating the web page content may be implemented by the same processor that implements the similarity engine 210, e.g. both implemented by a same server. In general, the similarity engine 210 may provide the information for output at the user interface 238 of the user device 230, either directly or via another device.

In step 264, the user device 230 may output the information (e.g. to the user) for the subset of the two or more other entities at the user interface 238. The user device 230 may, for example, output values of the one or more metrics (e.g. aggregated values of the one or more metrics) for the subset of the two or more other entities.

The method 250 may thus be used to dynamically identify at least one entity which is similar to a particular entity according to a selection of features received from the user device 230. In some embodiments, one or more of the steps of the method 250 may be performed on demand. For example, steps 256-264 may be performed responsive to step 254. This may enable identifying similar entities on demand according to a customizable definition of what makes two entities similar. This may be used, for example, as part of a dynamic benchmarking service e.g. for providing an entity with the performance metrics of a cohort of other, similar entities. In some embodiments, step 252 may be performed in advance. This may improve the responsiveness (e.g. may reduce the response time) of a service implemented using the method 250, for example. As a further benefit, the advantages described above may be achieved even in the absence of a pre-trained array of machine-learning models and/or previously collected/categorized data providing examples of which entities are similar for a given combination of features. This may enable rapid deployment of services, such as dynamic benchmarking services, employing the method 250.

In some embodiments, some of the steps of the method 250 may be performed in a different order. For example, step 252 may be performed after step 254. That is, the noise models may be obtained after receiving the selection of features in step 254. In some embodiments, only noise models for the selected features may be obtained in step 252. For example, the similarity engine 210 may receive, in step 254, a selection of features from the set of features and, in step 252, the similarity engine 210 may obtain a respective noise model for each feature in the selection of features. In some embodiments, step 252 may be performed responsive to step 254. Thus, the similarity engine 210 may obtain a noise model for each feature in the selection of features in response to receiving the selection of features from the user device 230.

### Filters

In some embodiments of the method 250, the similarity engine 210 may filter the entities that are identified as being similar to the particular entity. One or more filters may be applied to the inputs to the trained machine-learning model 258 (e.g. before the values are input in step 258). For example, the two or more other entities for which values of the selected features are input to the trained machine-learning model in step 258 may selected from a larger set of entities by filtering the larger set of entities using one or more filters.

Alternatively, one or more filters may be applied to the subset of the two or more other entities that are identified in 260. Thus, for example, the cohort of similar entities may be identified in step 260 and this cohort may be filtered using one or more filters to obtain a filtered set of entities. In step 262, the similarity engine 210 might only send information relating to entities in the filtered set of entities.

Thus, one or more filters may be used to exclude specific entities, or entities having particular feature values, from the entities for which information is returned to the user device 230. That is, entities that do not satisfy the one or more filters might be excluded from some of the steps of the method 250. The one or more filters may be configured by the user device 230 (e.g. by a user operating the user device 230). The similarity engine 210 may receive an indication of the one or more filters from the user device 230 e.g. via the network interface 214. The user device 230 may transmit the indication of the one or more filters to the similarity engine 210 via the network interface 234. In some embodiments, the user device 230 may output a set of filters on the user interface 238 and the user may select the one or more filters from the set of filters. For example, the user device 230 may display the set of filters to a user on a touchscreen and the user may select (e.g. by checking boxes, selecting buttons etc.) some of the displayed filters.

Technical advantages of using the filters may include reducing the information that is transmitted to the user device in step 262 without significantly impacting user experience. In particular, the filters may be used to exclude, from the entities for which information is sent in step 262, entities which might not be relevant to (e.g. of interest to) the user. As a result, information for these entities might not be sent in step 262, thereby reducing the quantity of information that is sent in step 262. This may reduce the network resources (e.g. bandwidth) that are used in step 262. Even in embodiments in which the information sent in step 262 is sent in aggregate, the use of filters may still have technical advantages. By excluding one or more entities using filters, the aggregate information sent in step 262 may be specific to entities that are relevant to the user, resulting in more relevant information being provided to the user. In addition, applying the filter to the inputs to the trained machine-learning model 258 (e.g. before the values are input in step 258) may provide further advantages by reducing the number of inputs to the trained machine-learning model. This may reduce the processing performed by the similarity engine in step 260 and thereby reduce the time taken to implement the method 250.

### Other Uses of the Method 250

In the description of the method 250 above, a subset of two or more other entities are identified as being similar to the particular entity in step 260 and information relating to entities in that subset is provided to the user device 230 in step 262 for output in step 264. In some embodiments, the method 250 may be used for (e.g. adapted for) a different purpose.

In some embodiments, the method 250 may be used to determine a similarity of one other entity and the particular entity. The similarity engine 210 may receive an indication of the one other entity from the user device 430. For example, a user may input (e.g. at the user interface 438) to the user device 430 that they wish to compare the other entity and the particular entity. The user device 430 may send, to the similarity engine 210, an indication of the other entity e.g. in addition to indicating the particular entity to the similarity engine 210. The similarity engine 210 may, in step 258, input values of the selected features for the particular entity and the other entity to the machine-learning model in order to obtain representations for the particular entity and the other entity. The similarity engine 210 may compare (e.g. determine a difference, such as distance, between) the representation for the other entity and the representation for the particular entity in order to determine their similarity. The similarity engine 210 may, for example, compute a similarity score (e.g. as defined above) for the other entity and the particular entity based on their representations. The similarity engine 210 may send the similarity score to the user device 430 for output at the user interface 438.

In general, the method 250 may be used to determine a similarity of the particular entity and one or more other entities.

In some embodiments, the method 250 may be used to cluster a plurality of entities into one or more groups (e.g. two or more groups) based on the representations for the plurality of entities. The plurality of entities may include the particular entity and the one or more other entities. In particular, the similarity engine 210 may, in step 258, input values of the selected features for the plurality of entities to the trained machine-learning model to obtain, for each entity in the plurality of entities, a respective representation of the values of the selected features for that entity. The similarity engine 210 may cluster the plurality of entities into one or more groups based on the obtained representations. The groups may or might not be predetermined. Thus, the similarity engine 210 may determine the one or more groups dynamically (e.g. based on the representations themselves). The similarity engine 210 may cluster the plurality of entities based on the representations using any suitable method e.g. using density-based clustering, centroid-based clustering, distribution based clustering and/or hierarchical clustering. The similarity engine 210 may send an indication of the entities clustered into (e.g. assigned to or associated with) each of the one or more groups to the user device 430 e.g. for output at the user interface 438.

A Machine-Learning Model that is Specific to a Particular Entity

In the method 250 described above, the trained machine-learning model is not specific to any particular entity. Instead, values of the selected features for any entity having the selected features may be input to the trained machine-learning model to generate a representation for that entity. In order to determine the similarity of two entities, values of the selected features for both entities may be input to the trained machine-learning model to generate respective representations for each of the two entities, and those representations may be compared to determine the similarity of the two entities.

In some embodiments, the trained machine-learning model may be specific to the particular entity (e.g. to the particular entity for which similar entities are to be identified). The machine-learning model may be trained to generate, based on the values of features for an entity, a representation of the values of those feature for that entity relative to values of the features of the particular entity. That is, a representation provided by the trained machine-learning model for an entity may, in itself, be a measure of the similarity of that entity to the particular entity. Thus, for example, the trained machine-learning model may provide a numeric vector representing the values of the selected features for an entity relative to the values of those features for the particular entity such that the length of the numeric vector indicates the similarity (or conversely, the difference) between the entity and the particular entity.

Accordingly, in some embodiments, step 258 described above may be modified such that only values of the selected features for the two or more other entities may be input to the trained machine-learning model (e.g. values of the selected features for the particular entity might not be input to the trained machine-learning model in step 258). As such, in step 258, the trained machine-learning model may provide representations of the values of the selected features for two or more other entities relative to the values of the selected features for the particular entity.

In some embodiments, the similarity of a particular entity and another entity may be determined using a trained machine-learning model that is specific to the other entity. Values of the selected features for the particular entity may be input to the trained machine-learning model to obtain a representation of the values of the selected features for that particular entity. As the trained-machine learning model is specific to the other entity, the representation provided by the trained machine-learning model for the particular entity may, in itself, be a measure of the similarity of the particular entity to the other entity.

### Training the Machine-Learning Model

As described above in respect of the method 250, a machine-learning model may be trained to generate, based on values of features for an entity, a representation of the values of those feature for that entity. The trained machine-learning model may be specific to a particular selection of features. That is, the trained machine-learning model may generate a representation for an entity that is based on (e.g. only on) values of the selected features.

An example method of training the machine-learning model is described with respect to FIG. 3. FIG. 3 illustrates a model trainer 300 for training a machine-learning model 302 according to one embodiment. The model trainer 300 may be used to train the machine-learning model in step 256 of the method 250, for example.

In the following description, the model trainer 300 is implemented in (e.g. by) the similarity engine 210 in step 256 of the method 250. For example, the processor 212 of the similarity engine 210 may implement the model trainer 300. In other embodiments, the model trainer 300 may be implemented elsewhere. For example, the similarity engine 210 may instruct another device that implements the model trainer 300 to train the machine-learning model 256 and receive, from the other device, the trained machine-learning model.

The model trainer 300 comprises a distorting unit 304 and an optimization function 306. It will be appreciated that the units 304, 306 merely illustrate how the functionality of the model trainer 300 may be implemented (e.g. by the similarity engine 210). It will be appreciated that the model trainer 300 may include more or fewer units than those described here. In some embodiments, one or more of the operations described below in respect of the units 304-306 may be performed by a processor (e.g. the processor 212 of the similarity engine) executing instructions stored in a memory (e.g. the memory 216) or stored in another computer-readable medium.

The model trainer 300 obtains values 314 of the selected features for a plurality of entities for training the machine-learning model 302. Thus, the model trainer 300 may obtain, for each entity in a plurality of entities used for training, a value for each of the selected features.

For non-numeric features, the values 314 of the features may have been encoded as numeric representations (e.g. as numbers, numeric vectors etc.). That is, the model trainer 300 may obtain numeric representations of the feature values. For example, for a feature “Country”, the model trainer 300 may obtain numeric vectors representing the (unencoded) values of the feature “Country”. The numeric representations may be defined as described above in respect of step 252, for example.

The model trainer 300 may receive the values 314 of the selected features (e.g. via the network interface 214). The model trainer 300 may receive the values 314 of the selected features from a server or a database, for example. In some embodiments, the model trainer 300 may receive the values 314 of the selected features from multiple devices e.g. multiple databases. In another example, the model trainer 300 may, for each entity in the second plurality of entities, receive the values 314 for the selected features for that entity from that entity. The model trainer 300 may thus collate feature values 314 received from the second plurality of entities.

In some embodiments, the model trainer 300 may receive the values 314 of the selected features for at least one of the plurality of entities on request. For example, the model trainer 300 may send (e.g. via the network interface 214) a request for values 314 of the selected features. The model trainer 300 may receive, in response, the values 314 of the set of features for the plurality of entities.

In some embodiments, the model trainer 300 may obtain the values 314 of the selected features responsive to the receipt of the selection of features. For example, the model trainer 300 may obtain the values 314 responsive to the similarity engine 210 receiving the selection of features in step 254 described above.

The model trainer 300 also obtains noise models 312 for the selected features. For training the machine-learning model 302. Thus, the model trainer 300 may obtain, for each of the selected features, a respective noise model.

The noise models may be defined as described above in respect of step 252. The noise models 312 may be selected from a larger set of noise models for a larger set of features. For example, the similarity engine 210 may obtain the noise models for a set of features in step 252 and, for training the machine-learning model in step 256, the noise models 312 for the features selected in step 254 may be selected from the set of noise models obtained in step 252.

As described above in respect of step 252, the noise model for a feature may be based on a distribution of the values of that feature for a plurality of entities. The plurality of entities involved in developing the noise models 312 might be the same or different to the plurality of entities for which the values 314 of the features are obtained as mentioned above. That is, the values 314 used for training the machine-learning model 302 may be for the same, different or overlapping entities as the values used to develop some or all of the noise models 312.

The noise models 312 and values of the selected features 314 are input to the distorting unit 304 to generate a first set of training pairs 316.

The first set of training pairs 316 may include, for each entity of at least some of the entities in the plurality of entities, respective entity data and corresponding distorted entity data. Each training pair in the first set of training pairs may correspond to a respective entity in the plurality of entities. The entity data for a training pair that corresponds to a particular entity may include the values of the selected features for that entity (e.g. from the values 314). The corresponding distorted entity data in the training pair may be generated by distorting a value of at least one of the selected features for the respective entity. That is, the distorting unit 304 may generate the distorted entity data by distorting some or all of the corresponding entity data. Distorting a value of a particular feature may include perturbing the value (e.g. by adding or subtracting a number from the value), scaling the value (e.g. multiplying or dividing the value by a factor) and/or substituting the value (e.g. replacing one value with another such as replacing the number “1” with the number “0”).

The value of a particular feature may be distorted based on the noise model for that feature. As described above, the noise model for a numeric feature may be based on a distribution of values for that feature. The value of a numeric feature may thus be distorted based on the distribution for that feature. The distribution on which the noise model for a numeric feature is based may be indicative of how significant a change in the value of the feature is. For example, if the noise model for a feature is based on a distribution with a standard deviation of $0.01, then changing the value of that feature by $0.02 might be a significant change. However, if the noise model for a feature is based on a distribution with a standard deviation of $1,000.00, then changing the value of that feature by $0.02 might not be a significant change.

In some embodiments, the value of a numeric feature having a noise model based on a particular distribution may be distorted by adding or subtracting a perturbation to/from the value, in which the perturbation is based on (e.g. less than) a standard deviation of the particular distribution. For example, a value of a feature having a noise model based on a Gaussian distribution with standard deviation of 2.5 may be distorted by adding a perturbation of 2.1 to the value of that feature. In some embodiments, the perturbation may be less than a fraction of the standard deviation of the particular distribution. For example, the perturbation may be less than 10% of the standard deviation of the particular distribution.

For non-numeric features, the value of a particular feature may be distorted by distorting the numeric representation of the value of that feature based on the noise model for that feature. A numeric vector representing the value of that feature may be distorted by distorting (e.g. perturbing, scaling and/or substituting) one or more elements of the numeric vector. For example, the numeric vector representing a value of a numeric feature having a noise model based on a particular multivariate distribution may be distorted by adding or subtracting a perturbation to/from an element of the numeric vector, in which the perturbation is based on (e.g. less than) a standard deviation of the particular distribution in a direction corresponding to that element. More generally, the numeric vector representing a value of a numeric feature having a noise model based on a particular multivariate distribution may be distorted by adding or subtracting respective perturbations to/from one or more elements of the numeric vector, in which each respective perturbation is based on (e.g. less than) a standard deviation of the multivariate distribution in a direction corresponding to that element. In some embodiments, each perturbation may be less than a fraction of the respective standard deviation. For example, the perturbation may be less than 10% of the respective standard deviation.

As the standard deviation of a distribution underlying the noise model for a feature may be indicative of the spread of that distribution, distorting a value of the feature based on the standard deviation may allow for introducing relatively small distortions to the feature values. In effect, the standard deviation(s) may be used to determine what constitutes a small distortion such that, even those some of the entity data is distorted to obtain the distorted entity data, the distorted entity data is still similar to the entity data.

For non-numeric features, the distorted numeric representation of a value of a feature might not correspond to a specific value of that feature. For example, a numeric vector corresponding to the value “Canada” of the feature “Country” might be distorted to obtain a distorted numeric vector. The distorted numeric vector might correspond to another country e.g. another country that is similar to the country “Canada”. Alternatively, the distorted numeric vector might not correspond to another country.

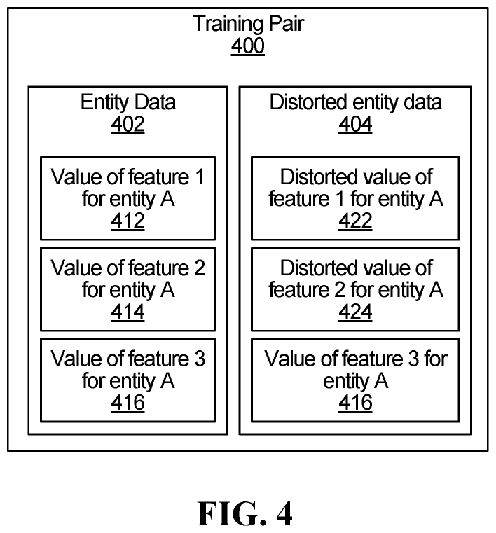

The structure of training pairs generated by the distorting unit 304 may be illustrated with reference to FIG. 4, which shows an example of a training pair 400 that may be generated by the distorting unit 304. The training 400 pair includes entity data 402 and distorted entity data 404 for a particular entity, entity A. The entity data 402 includes values 412, 414, 416 of selected features 1, 2 and 3 respectively. The distorted entity data 404 includes distorted values 422, 424 of features 1 and 2 respectively, and the (undistorted) value 416 of feature 3. The distorted values 422, 424 of features 1 and 2 are based on the values 412, 414 of features 1 and 2, and the respective noise models for features 1 and 2. For example, the value 412 of feature 1 may be a numeric vector representing the value “Canada” of the feature “Country”. The numeric vector may be, for example, [1,1,1,1]. The distorted value 422 of feature 1 may be the numeric vector [1,1,1,2], which does not represent the country “Canada”, but is similar. The distorted value 422 may be based on, for example, a multivariate Gaussian distribution of the numeric vectors representing the values of the feature “Country”, which may indicate that values of the first three elements of the numeric vectors are narrowly distributed (e.g. are unlikely to change by large values), but the value of the last element of the numeric vectors has a larger spread. As such, the noise distribution for feature 1 may indicate that distorting the numeric vector [1,1,1,1] (e.g. value 412 of feature 1) by adding the vector [0,0,0,1] to the numeric vector [1,1,1,1] is only a small change to feature 1. Thus, the noise models for the features may be used to distort the entity data in such a way that the distorted entity data (largely) still corresponds to the same entity. In this way, pairs of slightly different feature values for the same entity may be generated. This effectively provides the model trainer 300 with pairs of data for “similar” entities.

Thus, the entity data for each entity in the plurality of entities (that is, the values of the features for each entity) may be distorted to generate distorted entity data. The entity data and the distorted entity data for a particular entity may then form a training pair. In practice, the entity data for a particular entity may be distorted multiple times to generate more than one instance of distorted entity data. This may be used to generate multiple training pairs for a single entity. Thus, in general, one or more of the values of the features for each entity may be distorted one or more times to generate one or more training pairs, in which each training pair includes the values of the feature for that entity (e.g. the entity data) and respective distorted entity data. In some embodiments, the first set of training pairs may include a large number of training pairs for a particular entity. For example, the first set of training pairs may include more than one hundred training pairs for a particular entity (e.g. may include hundreds of training pairs for a particular entity). In some embodiments, different instances of distorted entity data for a particular entity may be generated by distorting the values of different features. Thus, for example, the distorted entity data in a first training pair for a particular entity may include the (undistorted) value of a first feature for that entity and a distorted value of a second feature for that entity, whilst the distorted entity data in a second training pair for that entity may include a distorted value of the first feature for that entity and the (undistorted) value of the second feature for that entity. In some embodiments, different instances of distorted entity data for a particular entity may be generated by distorting the values of the same features differently (e.g. perturbing the value of a particular feature by different amounts, scaling the value of a particular feature by different amounts and/or using different substitutions).

The model trainer 300 trains the machine-learning model 302 using the first set of training pairs 316. The machine-learning model 302 may be trained in one or more training iterations (e.g. one or more training cycles). One or more parameters of the machine-learning model 302 may initially (e.g. before training) be set to respective initial values. In each training iteration, the values of the one or more parameters of the model 302 may be updated and the updated model (e.g. the machine-learning model 302 using the updated parameters) may be used for the next training iteration.

In some embodiments, each training iteration may use training pairs corresponding to a single entity in the plurality of entities. For example, each training iteration may involve training the machine-learning model 302 using a batch of (e.g. hundreds of) training pairs for a particular entity. Alternatively, a single training iteration may use training pairs corresponding to different entities in the plurality of entities.

In a training iteration, the first set of training pairs 316 may be input to the machine-learning model 302 to obtain, for each training pair, representations of the entity data in that training pair and the distorted entity data in that training pair. That is, the machine-learning model 302 may output, for each training pair input to the model, a representation of the entity data in that training pair and a representation of the distorted entity data in that training pair. The entity data and the distorted entity data in a training pair may be input to the machine-learning model 302 together or separately. Thus, the first set of training pairs 316 may be input to the machine-learning model to obtain representations 318 of the entity data and the distorted entity data in each of the training pairs in the first set of training pairs 316.

In that training iteration, the optimization function 306 may determine updates 324 to one or more parameters of the machine-learning model. The optimization function may thus update 324 (e.g. adjust, modify, change, perturb etc.) one or more parameters of the machine-learning model 302 based on the representations 318. The optimization function 608 may, for example, update the parameters based on a loss function determined based on the representations 318.

The loss function may be based on a difference between the representations of the entity data and the representations of the distorted entity data for the training pairs. For example, the loss function may be based on a sum, over each of the training pairs, of the difference (e.g. a distance) between the representation of the entity data in each training pair and the representation of the distorted entity data in each training pair. For example, the representation of the entity data in a training pair may be equal to the numeric vector [2,3,4] and the representation of the distorted entity data in that training pair may be equal to the numeric vector [1,1,2]. The loss may be computed as a distance between the representation of the entity data and the representation of the distorted entity data e.g. \sqrt{(2−1)²+(3−1)²+(4−2)²}=3. Based on this loss value, at least one parameter of the machine-learning model 302 may be updated to try to reduce the loss value (e.g. bring it closer to zero) in future training iterations. Thus, the optimization function 306 may seek to optimize the machine-learning model such 302 such that it generates representations of values of features for an entity that are (largely) insensitive to the distortions introduced by the distortion unit 304. That is, the optimization function 306 may seek to minimize the distance between the (undistorted) entity data and the distorted entity data in a training pair. Since the entity data and the distorted entity data in a training pair correspond to the same entity, subject to some distortion introduced by the distorting unit 304, it is expected that they should be similar. This may be used to train the machine-learning model 302 to generate representations of the values of features for entities that are close to one another when the entities are similar (according to the selected set of features), and are far away from one another when the entities are different.

The optimization function 306 may, for example, seek to optimize (e.g. minimize) the loss function. The optimization function 306 may seek to minimize the loss function using any suitable optimization (e.g. minimization) process (e.g. algorithm) such as gradient-descent, Limited Memory Broyden-Fletcher-Goldfarb-Shanno algorithm (L-BFGS), Levenberg-Marquardt (LM) etc.

The parameters of the machine-learning model 302 that are updated by the optimization function 306 may depend on the type of machine-learning model. In some embodiments, the machine-learning model 302 may comprise a neural network such as a multilayer perceptron (e.g. an example of a feedforward artificial neural network). The parameters updated by the optimization function 306 may include, for example, one or more weights and/or one or more biases of the neural network, for example. In general, the machine-learning model 302 may be any suitable machine-learning model such as, for example, a decision tree, a support vector machine, a neural network etc.

After the values of the one or more parameters of the machine-learning model 302 are updated, the next training iteration may be performed e.g. another set of training pairs may be input to the (adjusted) machine-learning model 302. Each training iteration may thus use new training pairs. Thus, one or more of (e.g. all of) steps 258-260 may be repeated in each training iteration. In some embodiments, only the first set of training pairs 316 may be generated (e.g. step 258 may be performed only once), and each training iteration may use respective different subsets of training pairs from the first set of training pairs 316. Some of the training pairs of the first set of training pairs 316 might even be reserved for testing.

Training the machine-learning model 302 may continue until a particular number of training iterations have been reached. In some embodiments, the model trainer 300 may determine to stop training the machine-learning model 302 (e.g. may determine to not perform another training iteration) when training of the machine-learning model 302 has converged. Any suitable approach for assessing whether training of the machine-learning model 302 has converged may be used. For example, the model trainer 302 may determine to stop training the machine-learning model 302 when the difference between parameter values between different training iterations (e.g. a size of the updates) is below a threshold value.

After training, the machine-learning model 302 may be for generating, based on values of features for an entity, a representation of the values of those features for that entity. The trained machine-learning model may thus be used in step 260 of the method 250, for example. In general, the trained machine-learning model may be used in a variety of situations in which it is useful to assess the similarity of different entities.

Advantages of the method of training the machine-learning model described above may include the ability to train machine-learning models (e.g. for use in the method 250) on demand without user supervision and without an existing labelled training dataset. In particular, the generation of the training pairs based on the noise models enables the model trainer 300 to generate training data automatically e.g. as part of a self-supervised, or semi-supervised learning process. As a result, customized machine-learning models that are specific to features selected by a user may be generated on demand. This enables the provision of dynamic services which involve assessing the similarity of entities, such as dynamic benchmarking services, on demand.

### Labelled Training Pairs

As described above in respect of FIG. 3, the model trainer 300 may train the machine-learning model using a first set of training pairs 316 in which each training pair includes respective entity data and distorted entity data. In some embodiments, the distorting unit 304 may label the first set of training pairs 316 with a first label indicating that, for each training pair in the first set of training pairs 316, the entity data and the distorted entity data in that training pair are similar to one another. The distorting unit 304 may, for example, label each training pair in the first set of training pairs with a respective first label. Alternatively, the distorting unit 304 may use one first label for the first set of training pairs 316. In some examples, the distorting unit 304 may use one first label for each batch of training pairs that are input to the machine-learning model 302. As mentioned above, a batch may be the entire first set of training pairs or a subset of the first training pairs. The first label indicates, to the optimization function, that the entity data and the distorted entity data should be similar (e.g. the same) to one another. Responsive to the first label, the optimization function 306 may seek to minimize the difference between the representations of the entity data and the distorted entity data. Thus, rather than using a pre-labelled training set (e.g. as in supervised learning) or requiring a reward function for optimization (e.g. as in unsupervised learning), the model trainer 300 may form a labelled training set by forming pairs of entity data and distorted entity data.

In some embodiments, the model trainer 300 may also use a second set of training pairs (not illustrated) to train the machine-learning model 302. The second set of training pairs may be used to indicate what a pair of dissimilar entities may look like. In contrast to the first set of training pairs 302, each training pair in the second set of training pairs may comprise entity data including values of the selected features for each of two different entities. That is, a training pair in the second set of training pairs may comprise first entity data for a first entity and second entity data for a second entity, in which the first entity is different to the second entity. It is expected that the difference between entity data for two different entities should be more significant than the difference between the entity data and the distorted entity data for a single entity. Thus, the first set of training pairs may indicate, to the model trainer 300, what a pair of similar entities may look like, whilst the second set of training pairs may indicate, to the model trainer 300, what a pair of different entities may look like.

The second set of training pairs may be associated with a second label indicating that, for each training pair in the second set of training pairs, the entity data for the different entities are dissimilar to one another. Each training pair in the second set of training pairs may be labelled with a respective second label. Alternatively, one second label for the second set of training pairs may be used. In some examples, one second label may be used for each batch of training pairs in the second set of training pairs that are input to the machine-learning model 302. A batch may be the entire second set of training pairs or a subset of the second set of training pairs. The second label may indicate, to the optimization function, that the entity data for the two different entities should be dissimilar to one another.

The model trainer 300 may generate the second set of training pairs by pairing entities in the plurality of entities together. Entities may be paired together at random or more strategically. In some embodiments, the entities may be paired together by the distorting unit 304. The distorting unit 304 may be referred to as a training pair generator, for example.

In some embodiments, the optimization function 306 may use a loss function that is based on both the representations of the training pairs obtained from the machine-learning model 302 and the labels associated with those training pairs. For example, training pairs in the first set of training pairs may be associated with a first label equal to 0, indicating that they are similar, whilst training pairs in the second set of training pairs may be associated with a second label equal to 1, indicating that they are dissimilar. The optimization function 306 may determine, for each training pair in the first set of training pairs and the second set of training pairs, a difference (e.g. a distance) between the representations for that training pair. The representations provided by the machine-learning model 302 may be normalized such that the difference between the representations is constrained to a value between 0 and 1 (e.g. each representation may comprise a unit numeric vector, that is a numeric vector with a length less than or equal to one). The optimization function 306 may seek to minimize a difference between the difference (e.g. a distance) between the representations for a training pair and the label for the training pair. The optimization function 306 may thus, for example, seek to minimize a loss function based on the difference (e.g. a distance) between the representations for a training pair and the label for the training pair. As each training pair in the first set of training pairs includes entity data for the same entity, albeit subject to some distortion, the representations for training pairs in the first set of training pairs should be closer to one another (e.g. closer to 0, which is the value of the first label). As each training pair in the second set of training pairs includes entity data for two different entities, the representations for training pairs in the second set of training pairs should be further from one another (e.g. closer to 1, which is the value of the second label). As a result, adjusting one or more parameters of the machine-learning model 302 by minimizing a loss function based on the difference (e.g. a distance) between the representations for a training pair and the label for the training pair may effectively train the machine-learning model to provide more similar representations (e.g. representations that have a smaller difference between them) for similar entities and more different representations (e.g. representations that have a larger difference between them) for dissimilar entities.

In some embodiments, the number of training pairs in the second set of training pairs may be similar to the number of training pairs in the first set of training pairs 316. That is, though there may be many more pairs that are dissimilar than similar, a similar number of similar and dissimilar pairs may be used to train the machine-learning model 302. This may be achieved by limiting the number of training pairs that are generated for the second set of training pairs to be similar to (e.g. equal to, or of the same order of magnitude as) the number of training pairs in the first set of training pairs 316. Training the machine-learning model 302 with a similar number of first set of training pairs and a second set of training pairs (e.g. with a similar number of similar and dissimilar pairs) may cause the training of the machine-learning model 302 to converge more quickly.

As described above, the systems and methods described herein may be used in a range of situations in which it is useful to assess the similarity of different entities and/or identify similar entities.

### Dynamic Store Benchmarking

One use-case of the methods and systems described herein is the implementation of a dynamic benchmarking service for providing a merchant with performance metrics for a cohort of stores that are similar to their own. This may be referred to as a dynamic store benchmarking service.

It will be appreciated that the similarity of two stores may depend on the features according to which similarity is assessed. For example, Store A and Store B may be considered similar because they are in the same industry (“Fashion & Apparel”) and they both sell shoes. However, Store A may be more similar to another store, Store C, that sells hearing aids because Store A and Store C both mainly sell their products to women over 65, whereas the main customers of Store B are men aged 18-25. This is an example of similarity in customer demographic, and similarity may also be defined by features such as shipping logistics (e.g. two stores involved in the shipping and delivery of large or heavy items may be more similar than two stores physically close together, but one ships small light items), local delivery (e.g. two stores in the same neighbourhood may share similar local pickup or delivery options), etc. These aspects of a store (e.g. customer demographics, shipping logistics, etc.) can be represented as one or more numeric (e.g. quantitative) representations. As such, the method 250 may be used to identify stores that a similar to a merchant's store according to a selection of features for identifying similar stores. This may be used, as part of a dynamic benchmarking service, to provide values of metrics for stores that are similar to the merchant's store.

According to aspects of the present disclosure, a benchmarking service may operate as follows. The merchant may select, on a user device, features that are relevant to the merchant's definition of a similar store (e.g. the selection of features described above in step 254). The merchant may also select performance metrics of interest (e.g. conversion rate, net sales, average order value etc.). A machine-learning model that is specific to the selected set of features may be trained using values of the selected features for a set of stores and noise models for the selected features (e.g. as described above in step 256). Values of the selected features for the merchant's store and a set of other stores may be input to the trained machine-learning model to obtain representations (e.g. numeric representations such as vector representations) for the merchant's store and the other stores (e.g. as described above in step 258). The representation for the merchant's store may be compared to the representations for the other stores to identify a cohort of stores that are the most similar to the merchant's store (e.g. as described above in step 260). For example, the cohort may include the five stores that are most similar to the merchant's store. The performance metrics for the cohort of stores may be determined and aggregate values (e.g. percentile values of the performance metrics, such as the 25^{th}, 50^{th}, and/or 75^{th} percentile) may be output to the merchant at the user device (e.g. as described above in step 264).

The merchant may also select one or more filters that exclude some stores from the cohort. The filters may be applied before stores are input to the trained machine-learning model or after. For example, the merchant may indicate that they only wish to compare their store to stores from the US and Canada. As a result, only stores that are in the US and Canada may be input to the trained machine-learning model. Applying one or more filters to the stores before they are input to the trained machine learning model may reduce the number of stores that are input to the model, thereby reducing processing time.

### Example of a Dynamic Store Benchmarking Service

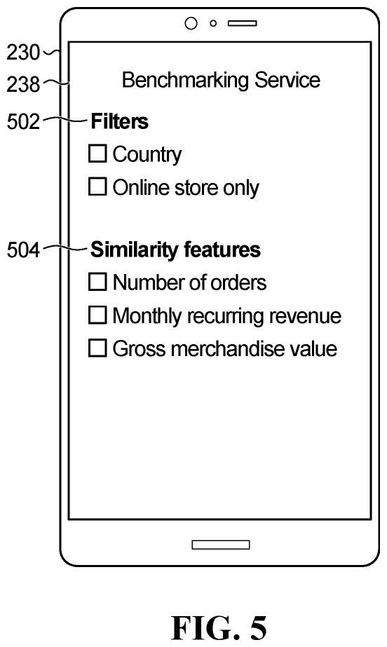

An example of a dynamic store benchmarking service is described with reference to FIGS. 5-9, which show the user device 230 according to one embodiment. The dynamic benchmarking service is for providing a merchant with one or more performance metrics of a cohort of stores that are similar to their own. The merchant's store may be an online store, a physical store (e.g. a brick and mortar store) or a store with an online and a physical presence. In this embodiment, the dynamic benchmarking service is implemented by the similarity engine 210 in communication with the user device 230. In other embodiments, the dynamic benchmarking service may be implemented by one or more other devices.

In this embodiment, the user interface 238 of the user device 230 includes a display screen on which information is displayed to the merchant. As illustrated in FIG. 5, the user device 230 displays a number of options for the dynamic benchmarking service, including two possible filters 502, and three possible similarity features 504.

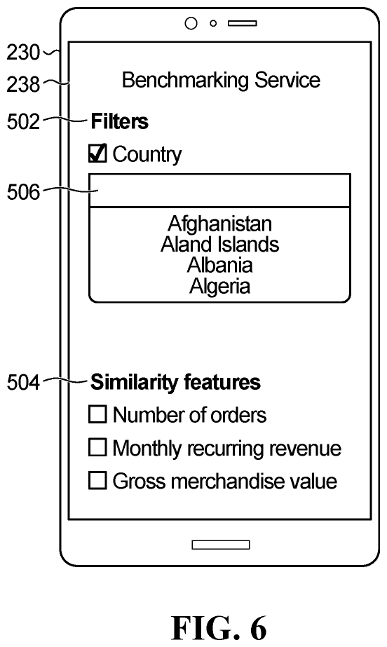

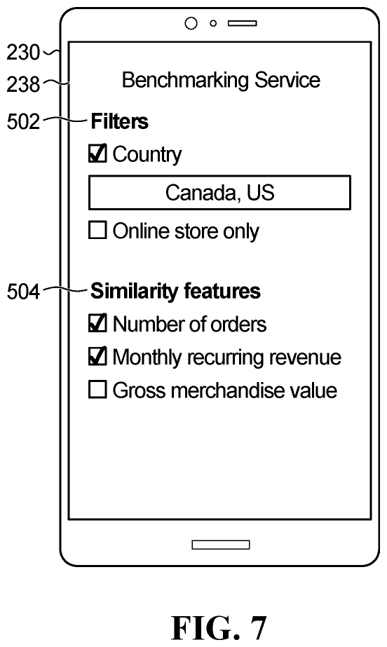

The two possible filters 902 include a first filter “Country” and a second filter “Online store only”. The user may select a particular filter by selecting the checkbox associating with that filter. Selecting a filter may allow the user to further specify the nature of that filter. This is illustrated in FIG. 6, which shows that, after the user has selected the “Country” filter, a dropdown list 506 of countries is presented to the user. The user may select one or more countries from the dropdown list. For example, in FIG. 7 the user has selected the countries “Canada” and the “US”, indicating that information should only be provided for entities that are in Canada or the US.

The two possible filters 502 are examples of the filters described above in respect of the method 250. It will be appreciated that the two possible filters 502 are merely examples of the filters that may be used. In other embodiments, other filters and/or a different number of filters (e.g. more or fewer filters) may be used. Examples of filters that may be used include: industry (e.g. a category such as “Fashion & Apparel”, “Health & Beauty”, “Electronics” etc.), a threshold GMV, country (e.g. primary market), a threshold AOV, a threshold monthly recurring revenue (MRR), active status (e.g. whether a store is still operating), a threshold conversion rate, a threshold number of orders, leaf product categories sold, a threshold number of daily sessions (e.g. threshold average or total over a time period, such as 30 days or 60 days), whether the store has (e.g. only has) an online presence, whether the store has (e.g. only has) a physical presence (e.g. a brick and mortar presence), whether the store is for a particular brand of product and/or whether the store is for multiple brands of products (e.g. whether the store is a curator) etc. Each threshold may be a minimum value, a maximum value or may define part of a range. Any suitable combination of filters may be used.

In this embodiment, the merchant selected the filter “Country” for use. In other embodiments, at least one filter may be used by the dynamic benchmarking service without having been selected by the user. For example, the developer of the dynamic benchmarking service may identify that including e.g. stores from a different country can skew the metrics provided by the dynamic benchmarking model and may thus determine to apply a filter that limits the metrics to only stores in the same country as the merchant's store. The filter may still be applied in the same manner as any filters selected by the user (e.g. using any of the approaches described above in respect of the method 250).

In some embodiments, the user device 230 might not display any possible filters to the merchant. For example, no filters might be used as part of the dynamic benchmarking service. In another example, one or more filters might be used in the dynamic benchmarking service, but they might not be configurable by the user (e.g. they may be configured by the developer).

The three possible similarity features 504 displayed on the user interface 238 include a first similarity feature “Number of orders”, a second similarity feature “Monthly recurring revenue” and a third similarity feature “Gross merchandise value”. The set of the three possible similarity features 504 are an example of the set of features described above in respect of the method 250. It will be appreciated that the possible similarity features 504 shown are merely examples of the features that may be included in the set of features output to the user. In other embodiments, other features, and/or a different numbers of features (e.g. more or fewer features) may be used. Examples of features that may be used include: industry (e.g. a category such as “Fashion & Apparel”, “Health & Beauty”, “Electronics” etc.), GMV, country (e.g. primary market), AOV, MRR, active status, conversion rate, number of orders, leaf product categories sold, daily sessions (e.g. average or total over a time period, such as 30 days or 60 days), whether the store has an online presence, whether the store has a physical presence (e.g. a brick and mortar presence), whether the store has both an online presence and a physical presence, whether the store is for a particular brand of product and/or whether the store is for multiple brands of products (e.g. whether the store is a curator) etc. Any suitable combination of features may be used.

As shown in FIG. 7, the merchant selects two of the possible similarity features 504 for use by the dynamic benchmarking service: “Number of orders” and “Monthly recurring revenue”. The merchant thus indicates that they wish the dynamic benchmarking service to return metrics for other stores that have similar numbers of orders and similar monthly recurring revenue. In this embodiment, the merchant selects the two similarity features by checking boxes shown on the user interface 238. In general, the merchant may select from a set of features output on the user interface 238 in any suitable way (e.g. by selecting buttons, highlight the selected features, selecting from a dropdown list etc.).

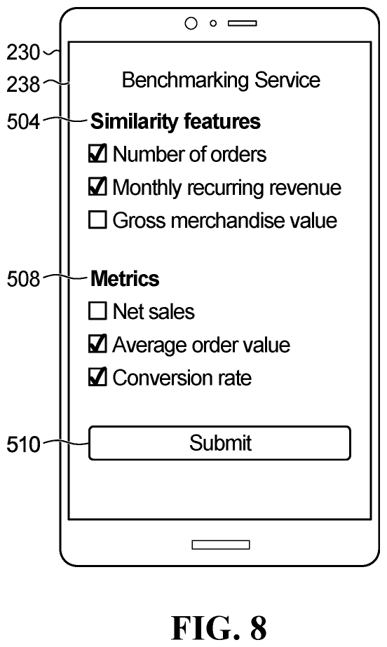

As shown in FIG. 8 the user device 230 may then display, on the user interface 238, three possible metrics 508 that may be provided by the dynamic benchmarking service. The three possible metrics 508 include a first metric “Net sales”, a second metric “Average order value” and a third metric “Conversion rate”. The set of the three possible metrics 508 are an example of the one or more metrics described above in respect of step 262 in the method 250. It will be appreciated that the three possible metrics 508 shown are merely examples of metrics that may be included in the one or more metrics provided by the dynamic benchmarking service. In other embodiments, other metrics and/or a different number of metrics (e.g. more or fewer metrics) may be used. Examples of metrics that may be used include: GMV, AOV, MRR, conversion rate, number of orders and/or daily sessions (e.g. average or total over a time period, such as 30 days or 60 days), etc. Any suitable combination of metrics may be used.

In this embodiment, the user device 230 might not display any possible metrics (e.g. metrics that the dynamic benchmarking service can provide) to the merchant. For example, the metrics provided by the dynamic benchmarking service might not be configurable by the user (e.g. they may be configured by the developer).

As shown in FIG. 8, the merchant selects the second and third metrics, “Average order value” and “Conversion rate”. The merchant thus indicates that they wish the dynamic benchmarking service to return values of these metrics for other, similar, stores. In this embodiment, the merchant selects the two metrics by checking boxes shown on the user interface 238. In general, the merchant may select from a set of metrics (e.g. possible metrics) output on the user interface 238 in any suitable way (e.g. by selecting buttons, highlight the selected features, selecting from a dropdown list etc.).

The user interface 238 also displays a button 510, labelled “Submit”. The merchant may click the submit button 510 in order to request from the dynamic benchmarking service values of selected metrics (e.g. “Average order value” and “Conversion rate”) for stores that are similar according to the similarity features selected by the merchant (e.g. stores with a similar number of orders and monthly recurring revenue), excluding stores that are excluded by the selected filters (e.g. excluding stores that are outside of the US and Canada). The user device 230 may, responsive to the merchant clicking the button 510, send the selection of the similarity features to the similarity engine 210 in accordance with step 254 described above. The user device 230 may additionally send an indication of the merchant's store (e.g. in the same request or a different request). This may indicate, to the dynamic benchmarking service that the store is the particular entity for which a cohort of other, similar entities (e.g. similar stores) should be identified. The user device 230 may additionally send any filters selected by the merchant (e.g. in the same request or a different request).

The similarity engine 210 may, responsive to receiving the request, perform steps 256-262 of the method 250 described above, using the selected similarity features as the selection of features, the selected metrics as the one or more metrics, and the selected filters as the one or more filters.

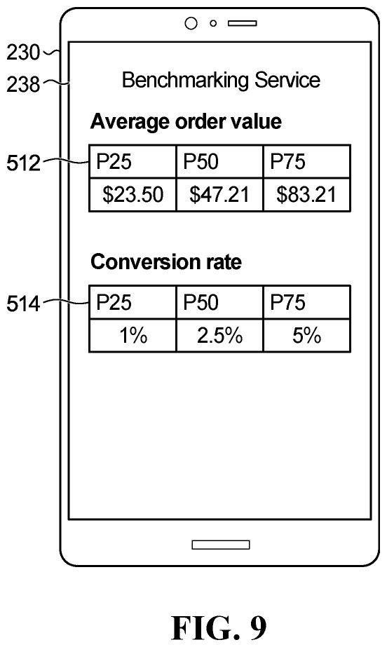

In this embodiment, the similarity engine 210 identifies 50 stores that are similar to the merchant's store (e.g. in accordance with step 260) and returns the percentile values for the selected metrics to the user device 430 (e.g. in accordance with step 262). As shown in FIG. 9, the user device 430 displays, on the user interface 238, the received percentile values (e.g. in accordance with step 264) to the merchant. In particular, the user device 230 displays the 25^{th}, 50^{th} and 75^{th} percentiles (labelled P25, P50 and P75 respectively) of the average order value 512 and the conversion rate 514 for the 50 stores that are similar to the merchant's store. Sending percentile values to the user device 230 allows for providing the merchant with useful information (e.g. that may allow them to determine whether the performance metrics for their store could be improved) whilst reducing the sensitive, potential identifiable information, from being sent e.g. over a network. As shown in FIG. 9, stores in the 25^{th} percentile of the cohort have an average order value of $23.50, stores at the 50^{th} percentile (e.g. the median) have an average order value of $47.21 and stores in the 75^{th} percentile have an average order value of $83.21. Stores in the 25^{th} percentile of the cohort have a conversion rate of 1%, stores at the 50^{th} percentile (e.g. the median) have a conversion rate of 2.5% and stores in the 75^{th} percentile have a conversion rate of 5%.

In this embodiment, the cohort of similar stores identified by the similarity engine 210 includes 50 stores. Cohorts with around 50 stores have been found to be both stable (e.g. their aggregated metrics do not experience significant fluctuations over time) and meaningful (e.g. they are small enough to still be sufficiently similar to the merchant's store). In other embodiments, the cohort of similar stores may include more or fewer stores. The number of stores in a cohort may be configurable by the merchant. For example, the merchant may input, into the user device 230, a desired number of stores in a cohort and the user device 230 may indicate the desired number of stores to the similarity engine 210. The similarity engine 210 may identify that desired number of stores as being similar to the merchant's store. For example, the merchant may indicate that the cohort is to include N stores, in which N is an integer. The similarity engine 210 may identify the N stores with the strongest (e.g. highest) similarity score as being similar to the merchant's store (e.g. in step 260).

An Example e-Commerce Platform

Although integration with a commerce platform is not required, in some embodiments, the methods disclosed herein may be performed on or in association with a commerce platform such as an e-commerce platform. Therefore, an example of a commerce platform will be described.

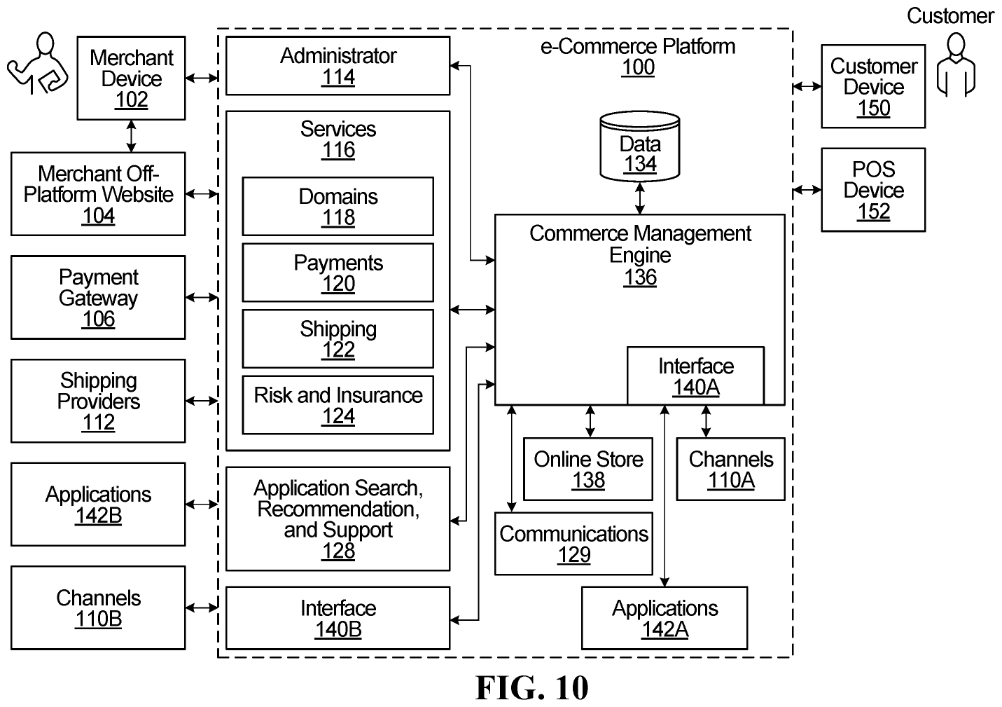

FIG. 10 illustrates an example e-commerce platform 100, according to one embodiment. The e-commerce platform 100 may be used to provide merchant products and services to customers. While the disclosure contemplates using the apparatus, system, and process to purchase products and services, for simplicity the description herein will refer to products. All references to products throughout this disclosure should also be understood to be references to products and/or services, including, for example, physical products, digital content (e.g. music, videos, games), software, tickets, subscriptions, services to be provided, and the like.

While the disclosure throughout contemplates that a ‘merchant’ and a ‘customer’ may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 100 should be understood to more generally support users in an e-commerce environment, and all references to merchants and customers throughout this disclosure should also be understood to be references to users, such as where a user is a merchant-user (e.g. a seller, retailer, wholesaler, or provider of products), a customer-user (e.g. a buyer, purchase agent, consumer, or user of products), a prospective user (e.g. a user browsing and not yet committed to a purchase, a user evaluating the e-commerce platform 100 for potential use in marketing and selling products, and the like), a service provider user (e.g. a shipping provider 112, a financial provider, and the like), a company or corporate user (e.g. a company representative for purchase, sales, or use of products; an enterprise user; a customer relations or customer management agent, and the like), an information technology user, a computing entity user (e.g. a computing bot for purchase, sales, or use of products), and the like. Furthermore, it may be recognized that while a given user may act in a given role (e.g. as a merchant) and their associated device may be referred to accordingly (e.g. as a merchant device) in one context, that same individual may act in a different role in another context (e.g. as a customer) and that same or another associated device may be referred to accordingly (e.g. as a customer device). For example, an individual may be a merchant for one type of product (e.g. shoes), and a customer/consumer of other types of products (e.g. groceries). In another example, an individual may be both a consumer and a merchant of the same type of product. In a particular example, a merchant that trades in a particular category of goods may act as a customer for that same category of goods when they order from a wholesaler (the wholesaler acting as merchant).

The e-commerce platform 100 provides merchants with online services/facilities to manage their business. The facilities described herein are shown implemented as part of the platform 100 but could also be configured separately from the platform 100, in whole or in part, as stand-alone services. Furthermore, such facilities may, in some embodiments, may, additionally or alternatively, be provided by one or more providers/entities.

In the example of FIG. 10, the facilities are deployed through a machine, service or engine that executes computer software, modules, program codes, and/or instructions on one or more processors which, as noted above, may be part of or external to the platform 100. Merchants may utilize the e-commerce platform 100 for enabling or managing commerce with customers, such as by implementing an e-commerce experience with customers through an online store 138, applications 142A-B, channels 110A-B, and/or through point of sale (POS) devices 152 in physical locations (e.g. a physical storefront or other location such as through a kiosk, terminal, reader, printer, 3D printer, and the like). A merchant may utilize the e-commerce platform 100 as a sole commerce presence with customers, or in conjunction with other merchant commerce facilities, such as through a physical store (e.g. ‘brick-and-mortar’ retail stores), a merchant off-platform website 104 (e.g. a commerce Internet website or other internet or web property or asset supported by or on behalf of the merchant separately from the e-commerce platform 100), an application 142B, and the like. However, even these ‘other’ merchant commerce facilities may be incorporated into or communicate with the e-commerce platform 100, such as where POS devices 152 in a physical store of a merchant are linked into the e-commerce platform 100, where a merchant off-platform website 104 is tied into the e-commerce platform 100, such as, for example, through ‘buy buttons’ that link content from the merchant off platform website 104 to the online store 138, or the like.

The online store 138 may represent a multi-tenant facility comprising a plurality of virtual storefronts. In embodiments, merchants may configure and/or manage one or more storefronts in the online store 138, such as, for example, through a merchant device 102 (e.g. computer, laptop computer, mobile computing device, and the like), and offer products to customers through a number of different channels 110A-B (e.g. an online store 138; an application 142A-B; a physical storefront through a POS device 152; an electronic marketplace, such, for example, through an electronic buy button integrated into a website or social media channel such as on a social network, social media page, social media messaging system; and/or the like). A merchant may sell across channels 110A-B and then manage their sales through the e-commerce platform 100, where channels 110A may be provided as a facility or service internal or external to the e-commerce platform 100. A merchant may, additionally or alternatively, sell in their physical retail store, at pop ups, through wholesale, over the phone, and the like, and then manage their sales through the e-commerce platform 100. A merchant may employ all or any combination of these operational modalities. Notably, it may be that by employing a variety of and/or a particular combination of modalities, a merchant may improve the probability and/or volume of sales. Throughout this disclosure the terms online store 138 and storefront may be used synonymously to refer to a merchant's online e-commerce service offering through the e-commerce platform 100, where an online store 138 may refer either to a collection of storefronts supported by the e-commerce platform 100 (e.g. for one or a plurality of merchants) or to an individual merchant's storefront (e.g. a merchant's online store).

In some embodiments, a customer may interact with the platform 100 through a customer device 150 (e.g. computer, laptop computer, mobile computing device, or the like), a POS device 152 (e.g. retail device, kiosk, automated (self-service) checkout system, or the like), and/or any other commerce interface device known in the art. The e-commerce platform 100 may enable merchants to reach customers through the online store 138, through applications 142A-B, through POS devices 152 in physical locations (e.g. a merchant's storefront or elsewhere), to communicate with customers via electronic communication facility 129, and/or the like so as to provide a system for reaching customers and facilitating merchant services for the real or virtual pathways available for reaching and interacting with customers.

In some embodiments, and as described further herein, the e-commerce platform 100 may be implemented through a processing facility. Such a processing facility may include a processor and a memory. The processor may be a hardware processor. The memory may be and/or may include a non-transitory computer-readable medium. The memory may be and/or may include random access memory (RAM) and/or persisted storage (e.g. magnetic storage). The processing facility may store a set of instructions (e.g. in the memory) that, when executed, cause the e-commerce platform 100 to perform the e-commerce and support functions as described herein. The processing facility may be or may be a part of one or more of a server, client, network infrastructure, mobile computing platform, cloud computing platform, stationary computing platform, and/or some other computing platform, and may provide electronic connectivity and communications between and amongst the components of the e-commerce platform 100, merchant devices 102, payment gateways 106, applications 142A-B, channels 110A-B, shipping providers 112, customer devices 150, point of sale devices 152, etc., In some implementations, the processing facility may be or may include one or more such computing devices acting in concert. For example, it may be that a plurality of co-operating computing devices serves as/to provide the processing facility. The e-commerce platform 100 may be implemented as or using one or more of a cloud computing service, software as a service (Saas), infrastructure as a service (IaaS), platform as a service (PaaS), desktop as a service (DaaS), managed software as a service (MSaaS), mobile backend as a service (MBaaS), information technology management as a service (ITMaaS), and/or the like. For example, it may be that the underlying software implementing the facilities described herein (e.g. the online store 138) is provided as a service, and is centrally hosted (e.g. and then accessed by users via a web browser or other application, and/or through customer devices 150, POS devices 152, and/or the like). In some embodiments, elements of the e-commerce platform 100 may be implemented to operate and/or integrate with various other platforms and operating systems.

In some embodiments, the facilities of the e-commerce platform 100 (e.g. the online store 138) may serve content to a customer device 150 (using data 134) such as, for example, through a network connected to the e-commerce platform 100. For example, the online store 138 may serve or send content in response to requests for data 134 from the customer device 150, where a browser (or other application) connects to the online store 138 through a network using a network communication protocol (e.g. an internet protocol). The content may be written in machine readable language and may include Hypertext Markup Language (HTML), template language, JavaScript, and the like, and/or any combination thereof.

In some embodiments, online store 138 may be or may include service instances that serve content to customer devices and allow customers to browse and purchase the various products available (e.g. add them to a cart, purchase through a buy-button, and the like). Merchants may also customize the look and feel of their website through a theme system, such as, for example, a theme system where merchants can select and change the look and feel of their online store 138 by changing their theme while having the same underlying product and business data shown within the online store's product information. It may be that themes can be further customized through a theme editor, a design interface that enables users to customize their website's design with flexibility. Additionally or alternatively, it may be that themes can, additionally or alternatively, be customized using theme-specific settings such as, for example, settings as may change aspects of a given theme, such as, for example, specific colors, fonts, and pre-built layout schemes. In some implementations, the online store may implement a content management system for website content. Merchants may employ such a content management system in authoring blog posts or static pages and publish them to their online store 138, such as through blogs, articles, landing pages, and the like, as well as configure navigation menus. Merchants may upload images (e.g. for products), video, content, data, and the like to the e-commerce platform 100, such as for storage by the system (e.g. as data 134). In some embodiments, the e-commerce platform 100 may provide functions for manipulating such images and content such as, for example, functions for resizing images, associating an image with a product, adding and associating text with an image, adding an image for a new product variant, protecting images, and the like.

As described herein, the e-commerce platform 100 may provide merchants with sales and marketing services for products through a number of different channels 110A-B, including, for example, the online store 138, applications 142A-B, as well as through physical POS devices 152 as described herein. The e-commerce platform 100 may, additionally or alternatively, include business support services 116, an administrator 114, a warehouse management system, and the like associated with running an on-line business, such as, for example, one or more of providing a domain registration service 118 associated with their online store, payment services 120 for facilitating transactions with a customer, shipping services 122 for providing customer shipping options for purchased products, fulfillment services for managing inventory, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In some embodiments, the e-commerce platform 100 may be configured with shipping services 122 (e.g. through an e-commerce platform shipping facility or through a third-party shipping carrier), to provide various shipping-related information to merchants and/or their customers such as, for example, shipping label or rate information, real-time delivery updates, tracking, and/or the like.

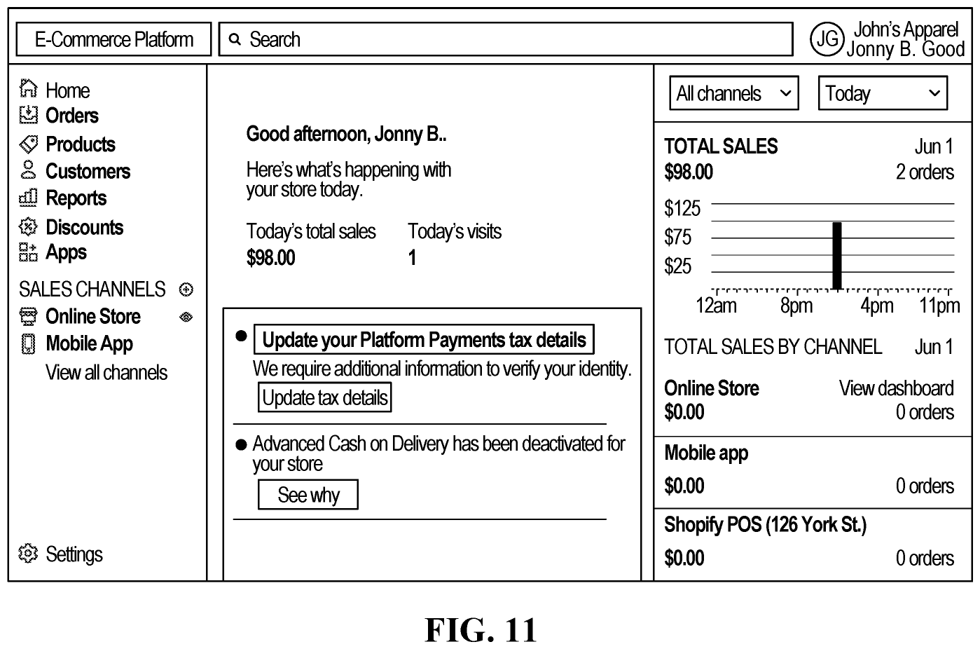

FIG. 11 depicts a non-limiting embodiment for a home page of an administrator 114. The administrator 114 may be referred to as an administrative console and/or an administrator console. The administrator 114 may show information about daily tasks, a store's recent activity, and the next steps a merchant can take to build their business. In some embodiments, a merchant may log in to the administrator 114 via a merchant device 102 (e.g. a desktop computer or mobile device), and manage aspects of their online store 138, such as, for example, viewing the online store's 138 recent visit or order activity, updating the online store's 138 catalog, managing orders, and/or the like. In some embodiments, the merchant may be able to access the different sections of the administrator 114 by using a sidebar, such as the one shown on FIG. 11. Sections of the administrator 114 may include various interfaces for accessing and managing core aspects of a merchant's business, including orders, products, customers, available reports and discounts. The administrator 114 may, additionally or alternatively, include interfaces for managing sales channels for a store including the online store 138, mobile application(s) made available to customers for accessing the store (Mobile App), POS devices, and/or a buy button. The administrator 114 may, additionally or alternatively, include interfaces for managing applications (apps) installed on the merchant's account; and settings applied to a merchant's online store 138 and account. A merchant may use a search bar to find products, pages, or other information in their store.

More detailed information about commerce and visitors to a merchant's online store 138 may be viewed through reports or metrics. Reports may include, for example, acquisition reports, behavior reports, customer reports, finance reports, marketing reports, sales reports, product reports, and custom reports. The merchant may be able to view sales data for different channels 110A-B from different periods of time (e.g. days, weeks, months, and the like), such as by using drop-down menus. An overview dashboard may also be provided for a merchant who wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's online store 138, such as based on account status, growth, recent customer activity, order updates, and the like. Notifications may be provided to assist a merchant with navigating through workflows configured for the online store 138, such as, for example, a payment workflow, an order fulfillment workflow, an order archiving workflow, a return workflow, and the like.

The e-commerce platform 100 may provide for a communications facility 129 and associated merchant interface for providing electronic communications and marketing, such as utilizing an electronic messaging facility for collecting and analyzing communication interactions between merchants, customers, merchant devices 102, customer devices 150, POS devices 152, and the like, to aggregate and analyze the communications, such as for increasing sale conversions, and the like. For instance, a customer may have a question related to a product, which may produce a dialog between the customer and the merchant (or an automated processor-based agent/chatbot representing the merchant), where the communications facility 129 is configured to provide automated responses to customer requests and/or provide recommendations to the merchant on how to respond such as, for example, to improve the probability of a sale.

The e-commerce platform 100 may provide a financial facility 120 for secure financial transactions with customers, such as through a secure card server environment. The e-commerce platform 100 may store credit card information, such as in payment card industry data (PCI) environments (e.g. a card server), to reconcile financials, bill merchants, perform automated clearing house (ACH) transfers between the e-commerce platform 100 and a merchant's bank account, and the like. The financial facility 120 may also provide merchants and buyers with financial support, such as through the lending of capital (e.g. lending funds, cash advances, and the like) and provision of insurance. In some embodiments, online store 138 may support a number of independently administered storefronts and process a large volume of transactional data on a daily basis for a variety of products and services. Transactional data may include any customer information indicative of a customer, a customer account or transactions carried out by a customer such as, for example, contact information, billing information, shipping information, returns/refund information, discount/offer information, payment information, or online store events or information such as page views, product search information (search keywords, click-through events), product reviews, abandoned carts, and/or other transactional information associated with business through the e-commerce platform 100. In some embodiments, the e-commerce platform 100 may store this data in a data facility 134. Referring again to FIG. 10, in some embodiments the e-commerce platform 100 may include a commerce management engine 136 such as may be configured to perform various workflows for task automation or content management related to products, inventory, customers, orders, suppliers, reports, financials, risk and fraud, and the like. In some embodiments, additional functionality may, additionally or alternatively, be provided through applications 142A-B to enable greater flexibility and customization required for accommodating an ever-growing variety of online stores, POS devices, products, and/or services. Applications 142A may be components of the e-commerce platform 100 whereas applications 142B may be provided or hosted as a third-party service external to e-commerce platform 100. The commerce management engine 136 may accommodate store-specific workflows and in some embodiments, may incorporate the administrator 114 and/or the online store 138.

Implementing functions as applications 142A-B may enable the commerce management engine 136 to remain responsive and reduce or avoid service degradation or more serious infrastructure failures, and the like.

Although isolating online store data can be important to maintaining data privacy between online stores 138 and merchants, there may be reasons for collecting and using cross-store data, such as, for example, with an order risk assessment system or a platform payment facility, both of which require information from multiple online stores 138 to perform well. In some embodiments, it may be preferable to move these components out of the commerce management engine 136 and into their own infrastructure within the e-commerce platform 100.

Platform payment facility 120 is an example of a component that utilizes data from the commerce management engine 136 but is implemented as a separate component or service. The platform payment facility 120 may allow customers interacting with online stores 138 to have their payment information stored safely by the commerce management engine 136 such that they only have to enter it once. When a customer visits a different online store 138, even if they have never been there before, the platform payment facility 120 may recall their information to enable a more rapid and/or potentially less-error prone (e.g. through avoidance of possible mis-keying of their information if they needed to instead re-enter it) checkout. This may provide a cross-platform network effect, where the e-commerce platform 100 becomes more useful to its merchants and buyers as more merchants and buyers join, such as because there are more customers who checkout more often because of the ease of use with respect to customer purchases. To maximize the effect of this network, payment information for a given customer may be retrievable and made available globally across multiple online stores 138.

For functions that are not included within the commerce management engine 136, applications 142A-B provide a way to add features to the e-commerce platform 100 or individual online stores 138. For example, applications 142A-B may be able to access and modify data on a merchant's online store 138, perform tasks through the administrator 114, implement new flows for a merchant through a user interface (e.g. that is surfaced through extensions/API), and the like. Merchants may be enabled to discover and install applications 142A-B through application search, recommendations, and support 128. In some embodiments, the commerce management engine 136, applications 142A-B, and the administrator 114 may be developed to work together. For instance, application extension points may be built inside the commerce management engine 136, accessed by applications 142A and 142B through the interfaces 140B and 140A to deliver additional functionality, and surfaced to the merchant in the user interface of the administrator 114.

In some embodiments, applications 142A-B may deliver functionality to a merchant through the interface 140A-B, such as where an application 142A-B is able to surface transaction data to a merchant (e.g. App: “Engine, surface my app data in the Mobile App or administrator 114”), and/or where the commerce management engine 136 is able to ask the application to perform work on demand (Engine: “App, give me a local tax calculation for this checkout”).

Applications 142A-B may be connected to the commerce management engine 136 through an interface 140A-B (e.g. through REST (REpresentational State Transfer) and/or GraphQL APIs) to expose the functionality and/or data available through and within the commerce management engine 136 to the functionality of applications. For instance, the e-commerce platform 100 may provide API interfaces 140A-B to applications 142A-B which may connect to products and services external to the platform 100. The flexibility offered through use of applications and APIs (e.g. as offered for application development) enable the e-commerce platform 100 to better accommodate new and unique needs of merchants or to address specific use-cases without requiring constant change to the commerce management engine 136. For instance, shipping services 122 may be integrated with the commerce management engine 136 through a shipping or carrier service API, thus enabling the e-commerce platform 100 to provide shipping service functionality without directly impacting code running in the commerce management engine 136.

Depending on the implementation, applications 142A-B may utilize APIs to pull data on demand (e.g. customer creation events, product change events, or order cancelation events, etc.) or have the data pushed when updates occur. A subscription model may be used to provide applications 142A-B with events as they occur or to provide updates with respect to a changed state of the commerce management engine 136. In some embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g. via the API 140A-B). In some embodiments, update events may be queued and processed asynchronously from a state change that triggered them, which may produce an update event notification that is not distributed in real-time or near-real time.

In some embodiments, the e-commerce platform 100 may provide one or more of application search, recommendation and support 128. Application search, recommendation and support 128 may include developer products and tools to aid in the development of applications, an application dashboard (e.g. to provide developers with a development interface, to administrators for management of applications, to merchants for customization of applications, and the like), facilities for installing and providing permissions with respect to providing access to an application 142A-B (e.g. for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, and the like. In some embodiments, applications 142A-B may be assigned an application identifier (ID), such as for linking to an application (e.g. through an API), searching for an application, making application recommendations, and the like.

Applications 142A-B may be grouped roughly into three categories: customer-facing applications, merchant-facing applications, integration applications, and the like. Customer-facing applications 142A-B may include an online store 138 or channels 110A-B that are places where merchants can list products and have them purchased (e.g. the online store, applications for flash sales (e.g. merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g. through applications related to the web or website or to mobile devices), run their business (e.g. through applications related to POS devices), to grow their business (e.g. through applications related to shipping (e.g. drop shipping), use of automated agents, use of process flow development and improvements), and the like. Integration applications may include applications that provide useful integrations that participate in the running of a business, such as shipping providers 112 and payment gateways 106.

As such, the e-commerce platform 100 can be configured to provide an online shopping experience through a flexible system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products through a number of different channels 110A-B such as, for example, the merchant's online store 138, a physical storefront through a POS device 152; an electronic marketplace, through an electronic buy button integrated into a website or a social media channel). In some cases, channels 110A-B may be modeled as applications 142A-B. A merchandising component in the commerce management engine 136 may be configured for creating, and managing product listings (using product data objects or models for example) to allow merchants to describe what they want to sell and where they sell it. The association between a product listing and a channel may be modeled as a product publication and accessed by channel applications, such as via a product listing API. A product may have many attributes and/or characteristics, like size and color, and many variants that expand the available options into specific combinations of all the attributes, like a variant that is size extra-small and green, or a variant that is size large and blue. Products may have at least one variant (e.g. a “default variant”) created for a product without any options. To facilitate browsing and management, products may be grouped into collections, provided product identifiers (e.g. stock keeping unit (SKU)) and the like. Collections of products may be built by either manually categorizing products into one (e.g. a custom collection), by building rulesets for automatic classification (e.g. a smart collection), and the like. Product listings may include 2D images, 3D images or models, which may be viewed through a virtual or augmented reality interface, and the like.

In some embodiments, a shopping cart object is used to store or keep track of the products that the customer intends to buy. The shopping cart object may be channel specific and can be composed of multiple cart line items, where each cart line item tracks the quantity for a particular product variant. Since adding a product to a cart does not imply any commitment from the customer or the merchant, and the expected lifespan of a cart may be in the order of minutes (not days), cart objects/data representing a cart may be persisted to an ephemeral data store.

The customer then proceeds to checkout. A checkout object or page generated by the commerce management engine 136 may be configured to receive customer information to complete the order such as the customer's contact information, billing information and/or shipping details. If the customer inputs their contact information but does not proceed to payment, the e-commerce platform 100 may (e.g. via an abandoned checkout component) transmit a message to the customer device 150 to encourage the customer to complete the checkout. For those reasons, checkout objects can have much longer lifespans than cart objects (hours or even days) and may therefore be persisted. Customers then pay for the content of their cart resulting in the creation of an order for the merchant. In some embodiments, the commerce management engine 136 may be configured to communicate with various payment gateways and services 106 (e.g. online payment systems, mobile payment systems, digital wallets, credit card gateways) via a payment processing component. The actual interactions with the payment gateways 106 may be provided through a card server environment. At the end of the checkout process, an order is created. An order is a contract of sale between the merchant and the customer where the merchant agrees to provide the goods and services listed on the order (e.g. order line items, shipping line items, and the like) and the customer agrees to provide payment (including taxes). Once an order is created, an order confirmation notification may be sent to the customer and an order placed notification sent to the merchant via a notification component. Inventory may be reserved when a payment processing job starts to avoid over-selling (e.g. merchants may control this behavior using an inventory policy or configuration for each variant). Inventory reservation may have a short time span (minutes) and may need to be fast and scalable to support flash sales or “drops”, which are events during which a discount, promotion or limited inventory of a product may be offered for sale for buyers in a particular location and/or for a particular (usually short) time. The reservation is released if the payment fails. When the payment succeeds, and an order is created, the reservation is converted into a permanent (long-term) inventory commitment allocated to a specific location. An inventory component of the commerce management engine 136 may record where variants are stocked, and may track quantities for variants that have inventory tracking enabled. It may decouple product variants (a customer-facing concept representing the template of a product listing) from inventory items (a merchant-facing concept that represents an item whose quantity and location is managed). An inventory level component may keep track of quantities that are available for sale, committed to an order or incoming from an inventory transfer component (e.g. from a vendor).

The merchant may then review and fulfill (or cancel) the order. A review component of the commerce management engine 136 may implement a business process merchant's use to ensure orders are suitable for fulfillment before actually fulfilling them. Orders may be fraudulent, require verification (e.g. ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g. credit card information) or wait to receive it (e.g. via a bank transfer, check, and the like) before it marks the order as paid. The merchant may now prepare the products for delivery. In some embodiments, this business process may be implemented by a fulfillment component of the commerce management engine 136. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g. at merchant managed locations) used when the merchant picks and packs the products in a box, purchase a shipping label and input its tracking number, or just mark the item as fulfilled. Alternatively, an API fulfillment service may trigger a third-party application or service to create a fulfillment record for a third-party fulfillment service. Other possibilities exist for fulfilling an order. If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g. including if there was any restocking fees or goods that weren't returned and remain in the customer's hands); and the like. A return may represent a change to the contract of sale (e.g. the order), and where the e-commerce platform 100 may make the merchant aware of compliance issues with respect to legal obligations (e.g. with respect to taxes). In some embodiments, the e-commerce platform 100 may enable merchants to keep track of changes to the contract of sales over time, such as implemented through a sales model component (e.g. an append-only date-based ledger that records sale-related events that happened to an item).

A Dynamic Benchmarking Service in the e-Commerce Platform 100

In some embodiments, a similarity engine, such as the similarity engine 210 described above, may be implemented inside of the e-commerce platform 100 e.g. in order to provide a benchmarking service, such as the dynamic benchmarking service described above.

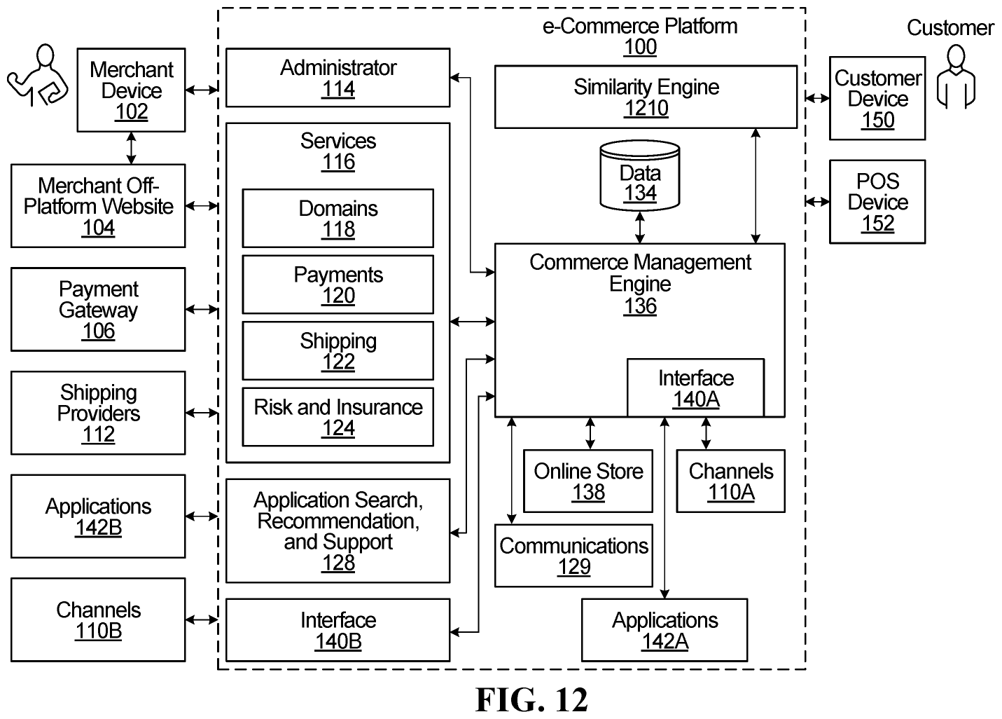

FIG. 12 illustrates the e-commerce platform 100 of FIG. 10, but with the addition of the similarity engine 1210 in communication with the commerce management engine 136.

Although the similarity engine 1210 in FIG. 12 is illustrated as a distinct component of the e-commerce platform 100 in communication with the commerce management engine 136, this is only an example. The similarity engine 1210 could also or instead be provided by another component residing within or external to the e-commerce platform 100. In some embodiments, either or both of the applications 142A-B may provide a similarity engine 1210 that implements the functionality described herein. The location of the similarity engine 1210 is implementation specific. In some implementations, the similarity engine 1210 is provided at least in part by an e-commerce platform, either as a core function of the e-commerce platform or as an application or service supported by or communicating with the e-commerce platform.

The similarity engine 1210 may be the similarity engine 210 described above. The similarity engine 1210 may be configured to, for example, perform one or more of the operations described as being performed by the similarity engine 1210 in the method 250 (e.g. to provide a benchmarking service to the merchant device 102). Thus, for example, the similarity engine 1210 may be configured to perform one or more of the following operations: obtaining noise models as described in step 252 (e.g. based on values received from the commerce management engine 136 and/or the data facility 134), training a machine-learning model as described in step 254 (e.g. by implementing the model trainer 300), inputting, to the trained machine-learning model, values of the selected features for a particular entity and two or more other entities as described in step 256 (e.g. in which the values may be received from the commerce management engine 136 and/or the data facility 134), identifying a subset of the two or more other entities as similar to the particular entity as described in step 260 and/or sending information relating to the subset of the two or more other entities (e.g. information relating to the similar entities) to the user device as described in step 262 (e.g. the information may be based on information for the entities in the subset from the commerce management engine 136 and/or the data facility 134).

The merchant device 102 may be operated by a user, such as a merchant, for example. The merchant device 102 may be configured to perform the operations described as being performed by the user device 230 in the method 250. Thus, for example, the merchant device 102 may be configured to perform one or more of the following operations: sending an indication of a subset of features selected by the user (e.g. the merchant) as described in step 254, receiving information relating to a subset of two or more other entities as described in step 262 and/or outputting information (e.g. to the user such as the merchant) for the subset of the two or more other entities at a user interface as in step 264.

In some embodiments, the merchant device 102 may function as the user device 430 in the description of FIGS. 5-9 above.

Although the embodiments described herein may be implemented using the similarity engine 1210 in e-commerce platform 100, the embodiments are not limited to the specific e-commerce platform 100 of FIGS. 10 to 12 and could be used in connection with any e-commerce platform. Also, the embodiments described herein need not necessarily be implemented in association with an e-commerce platform, but might instead be implemented as a standalone component or service.

### CONCLUSION

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

Although the present invention has been described with reference to specific features and embodiments thereof, various modifications and combinations may be made thereto without departing from the invention. The description and drawings are, accordingly, to be regarded simply as an illustration of some embodiments of the invention as defined by the appended claims, and are contemplated to cover any and all modifications, variations, combinations or equivalents that fall within the scope of the present invention. Therefore, although the present invention and its advantages have been described in detail, various changes, substitutions, and alterations may be made herein without departing from the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, any module, component, or device exemplified herein that executes instructions may include or otherwise have access to a non-transitory computer/processor-readable storage medium or media for storage of information, such as computer/processor-readable instructions, data structures, program modules, and/or other data. A non-exhaustive list of examples of non-transitory computer/processor-readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non-transitory computer/processor-readable storage media.

Memory, as used herein, may refer to memory that is persistent (e.g. read-only-memory (ROM) or a disk), or memory that is volatile (e.g. random access memory (RAM)). The memory may be distributed, e.g. a same memory may be distributed over one or more servers or locations.

1. A computer-implemented method comprising:
obtaining, for each feature in a set of features, a respective noise model;
receiving, from a user device, a selection of features from the set of features;
for each entity of a first plurality of entities used for training, obtaining a value for each of the selected features;
training a machine-learning model using a first set of training pairs, each training pair in the first set of training pairs comprising respective entity data paired with corresponding distorted entity data, wherein:
the respective entity data comprises values of the selected features for a respective entity in the first plurality of entities, and
the corresponding distorted entity data is obtained by distorting a value of at least one of the selected features for the respective entity based on the respective noise model for the at least one of the selected features; and
inputting, to the trained machine-learning model, values of the selected features for a particular entity to obtain a representation of the values of the selected features for that entity; and
determining a similarity between the particular entity and another entity based on the representation for the particular entity.

2. The computer-implemented method of claim 1, wherein the first plurality of entities includes at least one of the particular entity or the other entity.

3. The computer-implemented method of claim 1, further comprising:
inputting, to the trained machine-learning model, values of the selected features for the other entity to obtain a representation of the values of the selected features for the other entity, wherein the similarity between the particular entity and the other entity is determined based on the representation for the particular entity and the representation for the other entity.

4. The computer-implemented method of claim 1, wherein the other entity comprises two or more other entities, wherein determining the similarity between the particular entity and the two or more other entities comprises:
inputting, to the trained machine-learning model, values of the selected features for the two or more other entities to obtain representations of the values of the selected features for the two or more other entities; and
determining similarity scores for the two or more other entities compared to the particular entity based on the representations for the particular entity and the two or more other entities, the method further comprising:
identifying a subset of the two or more other entities as similar to the particular entity based on their respective similarity scores.

5. The computer-implemented method of claim 4, further comprising:
providing information relating to the subset of the two or more other entities for output at a user interface of the user device.

6. The computer-implemented method of claim 4, further comprising:
receiving, from the user device, an indication of one or more filters to be applied;
filtering the subset of the two or more other entities to obtain a filtered set of entities; and
providing information relating to the filtered set of entities for output at a user interface of the user device.

7. The computer-implemented method of claim 1, wherein the particular entity and the other entity are included in a second plurality of entities, and wherein determining the similarity between the particular entity and the other entity comprises determining the similarity between the particular entity and the other entity to cluster the second plurality of entities into one or more groups based on the representations for the second plurality of entities.

8. The computer-implemented method of claim 1, further comprising:
receiving, from the user device, an indication of one or more filters to be applied; and
selecting the particular entity from a larger group of entities based on the one or more filters.

9. The computer-implemented method of claim 1, wherein training the machine-learning model using the first set of training pairs comprises:
training the machine-learning model using the first set of training pairs and a first label, the first label indicating that, for each training pair in the first set of training pairs, the entity data and the distorted entity data in that training pair are similar to one another.

10. The computer-implemented method of claim 9, wherein a second set of training pairs and a second label are also used to train the machine-learning model,
each training pair in the second set of training pairs comprising entity data including values of the selected features for each of two different entities in the first plurality of entities, the second label indicating that, for each training pair in the second set of training pairs, the entity data for the different entities are dissimilar to one another.

11. The computer-implemented method of claim 1 wherein obtaining, for each feature in a set of features, the respective noise model comprises obtaining the noise model for a particular feature by performing operations including:
obtaining values of the particular feature for a second plurality of entities; and
determining the noise model for the particular feature based on the values of the particular feature for the second plurality of entities.

12. The computer-implemented method of claim 11 wherein the noise model for the particular feature in the set of features is based on a distribution of the values of the particular feature for the second plurality of entities.

13. The computer-implemented method of claim 11 wherein determining the noise model for the particular feature comprises:
encoding, for each entity in the second plurality of entities, the value of the particular feature to obtain respective numeric data for that entity; and
determining the noise model for the particular feature based on a distribution of the numeric data for the second plurality of entities.

14. The computer-implemented method of claim 13, wherein the noise model for the particular feature is based on a Gaussian distribution of the numeric data for the second plurality of entities.

15. The computer-implemented method of claim 13, wherein the particular feature comprises a category.

16. A system comprising:
a network interface to receive, from a user device, a selection of features from a set of features; and
a processor to:
obtain, for each feature in the set of features, a respective noise model;
for each entity of a first plurality of entities used for training, obtain a value for each of the selected features;
train a machine-learning model using a first set of training pairs, each training pair in the first set of training pairs comprising respective entity data paired with corresponding distorted entity data, wherein:
the respective entity data comprises values of the selected features for a respective entity in the first plurality of entities, and
the corresponding distorted entity data is obtained by distorting a value of at least one of the selected features for the respective entity based on the respective noise model for the at least one of the selected features; and
input, to the trained machine-learning model, values of the selected features for a particular entity to obtain a representation of the values of the selected features for that entity; and
determine a similarity between the particular entity and another entity based on the representation for the particular entity.

17. The system of claim 16, wherein the first plurality of entities includes at least one of the particular entity or the other entity.

18. The system of claim 16, wherein the processor is further to:
input, to the trained machine-learning model, values of the selected features for the other entity to obtain a representation of the values of the selected features for the other entity, wherein the similarity between the particular entity and the other entity is determined based on the representation for the particular entity and the representation for the other entity.

19. The system of claim 16 wherein the processor is to obtain, for each feature in a set of features, the respective noise model by performing operations including obtaining the noise model for a particular feature by:
obtaining values of the particular feature for a second plurality of entities; and
determining the noise model for the particular feature based on the values of the particular feature for the second plurality of entities.

20. A non-transitory computer readable medium having stored thereon computer-executable instructions that, when executed by a computer, cause the computer to perform operations comprising:
obtaining, for each feature in a set of features, a respective noise model;
receiving, from a user device, a selection of features from the set of features;
for each entity of a first plurality of entities used for training, obtaining a value for each of the selected features;
training a machine-learning model using a first set of training pairs, each training pair in the first set of training pairs comprising respective entity data paired with corresponding distorted entity data, wherein:
the respective entity data comprises values of the selected features for a respective entity in the first plurality of entities, and
the corresponding distorted entity data is obtained by distorting a value of at least one of the selected features for the respective entity based on the respective noise model for the at least one of the selected features; and
inputting, to the trained machine-learning model, values of the selected features for a particular entity to obtain a representation of the values of the selected features for that entity; and
determining a similarity between the particular entity and another entity based on the representation for the particular entity.
